(19) United States
(12) Patent Application Publication
(10) Pub. No.: US 2024/0326942 A1
(43) Pub. Date: Oct. 3, 2024

(54) Connecting Device for Connecting a Battery Pack to an Electric Bike

(71) Applicant: Robert Bosch GmbH, Stuttgart (DE)

(72) Inventors: Fabian Philipzik, Tuebingen (DE); Michael Stengele, Schwenningen (DE); Aaron Ruthardt, Hildrizhausen (DE); Chris Haid, Lichtenstein (DE); Christoph Sautter, Eningen (DE); Florian Wolff, Unterberken (DE); Jeffrey-Marco Moritz, Frickenhausen (DE); Julia Joerg, Stuttgart (DE); Julian Schwietert, Reutlingen (DE); Marc Dietzen, Langenargen (DE); Simon Gerold, Stuttgart (DE); Simon Buck, St. Johann (DE); Simone Schramm, Tuebingen (DE)

(21) Appl. No.: 18/616,812

(22) Filed: Mar. 26, 2024

(30) Foreign Application Priority Data
Mar. 31, 2023 (DE) 10 2023 203 034.9

(51) Int. Cl. B62J 43/20; B62J 43/13

(52) U.S. Cl. CPC B62J 43/20; B62J 43/13

(57) ABSTRACT

A connecting device for connecting a battery pack to an electric bike includes a guide unit for linear guidance of the battery pack in the connection process, and a locking unit for locking the battery pack to the electric bike. The locking unit is arranged on a first section of the guide unit. The connecting device is designed such that the battery pack can be connected to the electric bike exclusively by way of a linear movement. The connecting device includes a securing unit for securing the battery pack in the unlocked state. The securing unit includes a movable securing element.

This application claims priority under 35 U.S.C. § 119 to patent application no. DE 10 2023 203 034.9, filed on Mar. 31, 2023 in Germany, the disclosure of which is incorporated herein by reference in its entirety.

### BACKGROUND

DE 20 2016 104 156 U1 describes a device for securing the removal of an accumulator. DE 10 2021 104 606 A1 describes a battery pack for a means of transportation comprising a connecting device.

### SUMMARY

The disclosure relates in particular to a connecting device for connecting a battery pack to an electric bike, said device comprising a guide unit for linear guidance of the battery pack in the connection process, and comprising a locking unit for locking the battery pack to the electric bike, the locking unit being arranged on a first section of the guide unit and comprising a securing unit for securing the battery pack in the unlocked state. It is proposed that the securing unit is arranged on a second section of the guide unit, whereby the securing unit comprises a movable securing element. The advantage of this is that the battery pack can be removed particularly safely.

The connecting device can be arranged completely or partially on the electric bike. Alternatively or additionally, it is conceivable that the connecting device is arranged completely or partially on the battery pack.

The battery pack is designed in particular as an exchangeable battery pack, which is preferably designed to be detached from the consumer without tools. The battery pack is in particular designed to be connectable to a charging device for charging the battery pack. Alternatively or additionally, the battery pack can also be designed such that it can be charged when it is connected to the consumer, e.g., via a charging socket on the battery pack or on the frame of the electric bike. The battery pack comprises a housing in which at least one battery cell is arranged. The housing of the battery pack comprises at least one housing part. The housing is preferably designed as an outer housing, whereby the individual housing parts are also designed as outer housing parts. In the context of this application, an outer housing part is in particular understood to mean a housing part which closes off the battery pack from the outside when mounted. The housing of the battery pack can be made of metal and/or plastic. The battery cell can, e.g., be designed as a Li-ion battery cell. In particular, the battery cell can be designed as a cylindrical round cell, a prismatic cell, or a pouch cell. Preferably, a cell holder is arranged in the housing of the battery pack to receive the battery cells. The cell holder is partially or completely arranged within the housing of the battery pack. The housing of the battery pack can comprise one or multiple cell holders. The cell holder can comprise individual cell receptacles that are designed to receive a single battery cell. The cell holder is preferably designed integrally and made of a metallic material or plastic.

In the context of this application, an electric bike is in particular understood to mean a bicycle which comprises a drive unit for assisting the rider. The electric bike is preferably designed as an e-bike, a pedelec, a cargo bicycle, a folding bicycle, or the like. The drive unit comprises a motor which can, e.g., be designed as a mid-drive motor or as a hub motor. The motor is preferably designed as an electric motor. The drive unit is connected to the battery pack to supply the drive unit with energy. The electric bike comprises an electronic system comprising a control unit for controlling or regulating the electric bike. The electronic system preferably comprises a sensor unit, in which case the sensor unit can comprise, e.g., motion sensors, torque sensors, speed sensors, a GNSS receiver, magnetic sensors, or the like. The electronic system further comprises a communication interface for wirelessly connecting the electric bike to an external device, e.g., a smartphone and/or a server. The electric bike can further comprise further add-on components or peripherals, such as a board computer, an in particular electronic shift control, a lighting unit for lighting the roadway and/or as a rear light, an anti-blocking system, a lock, and/or another component, or can be designed to be connectable thereto.

The guide unit comprises at least one guide element, which is designed to guide the battery pack in or on the electric bike during the connection process. In particular, the guide unit comprises several guide elements, whereby at least one guide element is arranged on the battery pack and at least one corresponding guide element is arranged on the electric bike. The guide element can, by way of example, be designed as a guide rail or a guide groove. The guide element can be designed integrally or in one piece with the electric bike, in particular with a frame of the electric bike. In the context of this application, “integrally” is understood to mean that multiple elements are manufactured from one piece and are therefore not connected to each other in any frictional, interlocking, or bonded manner. In the context of this application, “in one piece” is in particular understood to mean two elements that are connected to one another in a bonded manner.

In the context of this application, a connection process is understood to mean the process between an unconnected state of the battery pack with the electric bike to a connected state of the battery pack with the electric bike, as well as the reverse sequence. In the connected state, the battery pack is mechanically and, in particular, electrically connected to the electric bike, preferably locked. In the connected state, there is at least some mechanical contact between the electric bike and the battery pack. The connection process can in this case take place simply by moving the battery pack relative to the electric bike, or by means of additional actuation by the user. In the connected state, the battery pack can be provided in a locked or unlocked state. In the unlocked state, the battery pack is preferably electrically disconnected from the electric bike. This essentially corresponds to a secondary locking mechanism in particular.

The locking unit is designed such that the locking mechanism can only be released by actuating the locking unit.

Furthermore, it is proposed that the connecting device is designed such that the battery pack can be connected to and/or detached from the electric bike via a swivel movement and a linear movement. As a result, a convenient connection process can be achieved in an advantageous manner. In particular, there is a swivel movement or linear movement of the complete battery pack and/or at least part of the battery pack relative to the electric bike.

It is further proposed that the first section and the second section of the guide unit are arranged on opposite sides of the guide unit. The sections can be designed to partially overlap or be completely separate from each other.

It is also proposed that the locking unit can be designed to be actuated such that the battery pack is partially ejected linearly along the guide unit during unlocking. As a result, a particularly convenient removal of the battery pack can be achieved in an advantageous manner. The ejection is in this case preferably only partial along an area of a few cm.

Furthermore, it is proposed that the locking unit comprises at least one movable locking element, with the locking element in particular being designed as pre-tensioned in the locked state. Advantageously, an ejection mechanism for the battery pack can be provided by pre-tensioning the locking element. The locking element is preferably designed to be movable relative to the electric bike and the battery pack. The locking element can be mounted on the electric bike or the battery pack so that it can move rotationally and/or linearly.

Furthermore, it is proposed that the locking unit is coupled to an actuating unit, via which the locking unit is preferably designed to be manually actuated. The actuating unit is designed in particular as a lock. The lock is preferably designed so that it can be actuated using a key. Alternatively, it is also conceivable that the actuating unit could be designed as a switch, a button, a knob or similar and thus be actuated directly by the user's hand. Alternatively or additionally, the actuating unit can also be designed to be electronically controllable and comprise an actuator. The control can in this case be performed via, e.g., application software on a mobile device, or a fingerprint sensor.

It is also proposed that the locking unit comprises a linear bearing for supporting the battery pack in the locked state. The advantage of this is that the battery pack can be stored securely in locked state.

Furthermore, it is proposed that the securing unit comprises a retaining element that only holds the battery pack on the electric bike in the locked state. The retaining element can be arranged on the electric bike, in particular the frame of the electric bike, or the battery pack. The retaining element is particularly designed to be rigid. Preferably, the retaining element is arranged on the guide unit, whereby the retaining element is designed integrally or in one piece with the guide unit, in particular a guide element of the guide unit.

Furthermore, it is proposed that the securing element is designed as a stop against which the battery pack rests in the unlocked state. As a result, the battery pack can be held securely in the unlocked state in an advantageous manner. In the locked state, the battery pack is arranged at a distance from the stop of the securing element.

It is also proposed that the securing element is connected to the guide unit, whereby the securing element is designed in particular as a metal sheet metal spring. The securing element can be designed integrally or in one piece with the guide unit or be formed in a force-fit and/or form-fit with the guide unit, in particular a guide element of the guide unit. The securing element is in particular designed to be manually actuated.

Furthermore, the disclosure relates in particular to an electric bike with a connecting device, as described hereinabove.

Furthermore, the disclosure relates in particular to a battery pack for the electric bike.

The disclosure relates to a connecting device for connecting a battery pack to an electric bike, comprising a guide unit for linear guidance of the battery pack in the connection process, comprising a locking unit for locking the battery pack to the electric bike, whereby the locking unit is arranged on a first section of the guide unit, whereby the connecting device is designed such that the battery pack can be connected to the electric bike exclusively via a linear movement. It is proposed that the connecting device comprises a securing unit for securing the battery pack in the unlocked state, whereby the securing unit comprises a movable securing element. As a result, a particularly secure connection process can be achieved in an advantageous manner.

The connection process is preferably designed as an insertion into a frame or as a sliding of the battery pack onto the electric bike.

It is further proposed that the securing unit is arranged on the first section or on the second section of the guide unit. The first section and the second section can be designed to be partially overlapping or completely separate from each other.

It is also proposed that the securing element is designed to be directly actuated. As a result, the removal of the battery pack can be simplified in an advantageous manner. In particular, the locking unit can be designed to be actuated such that the battery pack is partially ejected during unlocking, whereby the ejected battery pack is advantageously caught by the securing unit.

Alternatively, the disclosure relates to a connecting device for connecting a battery pack to an electric bike, with a locking unit for locking the battery pack to the electric bike, whereby the locking unit is coupled to an actuating unit, via which the locking unit is preferably designed to be manually actuated, whereby the actuating unit is accommodated in a receptacle housing of the locking unit along a receptacle direction. It is proposed that the connecting device is designed such that the actuating unit can be fixed at least at a first position, and at a second position within the receptacle housing along the receptacle direction. As a result, the connecting device can be optimally adapted to the electric bike in an advantageous manner.

Furthermore, it is proposed that the actuating unit comprises a first connecting element and the receptacle housing comprises a second connecting element for the frictional and/or interlocking connection of the actuating unit to the receptacle housing. As a result, an effective connection can be ensured in an advantageous manner.

Furthermore, it is proposed that the actuating unit comprises at least two first connecting elements and/or the receptacle housing comprises at least two second connecting elements, which are designed to connect the actuating unit to the receptacle housing via a positioning element. A simple assembly can be advantageously enabled by means of the positioning element.

It is also proposed that the positioning element comprises a fixing section for fixing the positioning element in the actuating unit. As a result, effective fixation can be provided in an advantageous manner. The fixing section is preferably designed to be essentially pin-shaped.

Furthermore, it is proposed that the fixing section is designed to be resilient such that a frictional connection is created between the positioning element and the first connecting element and/or the second connecting element.

Furthermore, it is proposed that the positioning element comprises a retaining section for fastening the positioning element to the receptacle housing. The retaining section is preferably designed to fix the positioning element to the receptacle housing. The retaining section is preferably designed such that it can be gripped by the user to release the connection.

It is also proposed that the first connecting element and/or the second connecting element is designed as a recess. Preferably, the first connecting element and/or the second connecting element is designed as an elongated hole.

Furthermore, it is proposed that the first connecting element and the second connecting element are designed to be directly connectable to each other. As a result, a compact design can be achieved in an advantageous manner.

Furthermore, it is proposed that the first connecting element and/or the second connecting element is designed as a thread. Advantageously, the connecting elements can be connected to each other using a screw connection.

It is also proposed that the first connecting element and/or the second connecting element is designed as a latching element or a plurality of latching elements. Advantageously, this allows the connecting elements to be connected to each other in a variety of positions.

Alternatively, the disclosure relates to a battery pack, in particular an exchangeable battery pack comprising a housing in which at least one battery cell is arranged, whereby the housing is designed as an outer housing and whereby the housing comprises at least two housing parts, whereby the housing has a ribbed structure comprising a plurality of ribs on an outer surface facing away from the at least one battery cell, whereby the ribs are designed integrally with the housing. It is proposed that the ribbed structure occupies at least 40% of the outer surface of the housing. This has the advantage of optimizing the thermal and mechanical properties of the battery pack and/or saving weight.

Furthermore, it is proposed that at least one of the housing parts is made of plastic and comprises the ribbed structure. Alternatively or additionally, it is also conceivable that the battery pack comprises a metallic housing part, on which the ribbed structure is formed. In particular, the ribbed structure consists of a plastic.

Furthermore, it is proposed that the ribs have a particularly uniform height, the height preferably being in a range between 0.05 mm and 1 mm. This has the advantage of further optimizing the thermal and mechanical properties.

It is also proposed that the housing part comprising the ribbed structure has a thickness in the range from 0.7 mm to 2.5 mm. This has the advantage of further optimizing the thermal and mechanical properties.

It is further proposed that a ratio between the height of the ribs and the thickness of the housing part is in a range between 0.07 and 0.4. This has the advantage of further optimizing the thermal and mechanical properties.

Furthermore, it is proposed that the ribs are at least in some areas, preferably essentially always, at a particularly uniform distance from one another, the distance being in a range between 0.5 mm and 2 mm. As a result, the thermal and mechanical properties can be further optimized in an advantageous manner.

It is also proposed that the distance between neighboring ribs is less than 20% of the diameter of the at least one battery cell. As a result, the thermal and mechanical properties can be further optimized in an advantageous manner.

It is further proposed that the ribs preferably extend without interruption along the entire housing part. As a result, the thermal and mechanical properties can be further optimized in an advantageous manner.

It is further proposed that the ribs are arranged at least in sections on a curved outer surface such that adjacent ribs extend away from each other. This has the advantage of further optimizing the thermal and mechanical properties.

It is further proposed that the ribs feature angular edges or rounded edges. As a result, the thermal and mechanical properties can be further optimized in an advantageous manner.

Alternatively, the disclosure relates in particular to a connecting means, in particular a connecting plate, for a battery pack, whereby the connecting means comprises at least one fastening element for fastening the connecting means to a housing part of the battery pack, whereby the connecting means is designed for releasable connection of the battery pack to a consumer comprising at least one functional section which projects beyond the housing part of the battery pack in the state connected to the battery pack. It is proposed that the functional section features at least two functions. Additional functions can be integrated into the fastener as a precautionary measure.

The functions are preferably provided by functional elements, e.g. a guide element, a securing element, a locking element, a retaining element, a centering element, a bearing element, or the like. The at least one functional section comprises at least two functional elements.

In state fastened to the battery pack, the connecting means is part of the battery pack and is provided in various configurations in order to adapt the battery pack to various connecting devices and/or to various types of installation of the battery pack in the electric bike. Preferably, the battery pack is designed to be connectable with at least two connecting means, whereby the battery pack can be optimally adapted to the electric bike by selecting the connecting means.

In the context of this application, “projecting beyond the housing part of the battery pack” is to be understood in particular to mean that the connecting means projects laterally with respect to the housing part of the battery pack when viewed along the longitudinal projection of the battery pack and thus enlarges the outer contour of the battery pack in at least two dimensions, preferably in three dimensions.

It is further proposed that the connecting means comprises at least two functional sections on adjacent and/or opposite sides. Additional functions can advantageously be achieved as a result.

Furthermore, it is proposed that the connecting means comprises at least three functional sections, each of which is arranged in different quadrants when viewed in cross-section. Additional functions can be achieved as a result.

It is also proposed that the functional section comprises at least one guide element for guiding the battery pack during a connection process. As a result, optimum guidance of the battery pack during the connection process can be advantageously ensured. The guide element of the functional section is preferably designed to correspond to a guide element of the guide unit on the electric bike. The guide element of the functional section can, e.g., comprise a sliding surface.

Furthermore, it is proposed that the guide element comprises at least one insertion slope. As a result, guidance can be improved in an advantageous manner.

It is further proposed that the guide element comprises a preferably elastic damping element and/or a reinforcing element. As a result, a robust fastener can be provided in an advantageous manner. The damping element and the guide element can be designed integrally, in one piece, or in multiple pieces. The damping element can be made of an elastic plastic, in particular rubber, or formed as a spring element. The reinforcing element and the guide element can be designed integrally, in one piece, or in multiple pieces. The reinforcing element can be made of a metallic material and/or a thickened material.

It is also proposed that the functional section comprises a connecting element for connecting the connecting means to a corresponding linear bearing element of the consumer. As a result, it is possible to create a robust connection between the battery pack and a consumer, in particular an electric bike. Furthermore, it is proposed that the connecting element is designed as an opening, in particular as a rectangular opening, preferably as an L-shaped opening. The battery pack can also be designed for other consumers, e.g. a garden tool, a household appliance, or a machine tool.

It is further proposed that the functional section comprises at least one connecting element directed in the direction of the housing part of the battery pack, in particular in the direction of the longer housing part. As a result, the connection can be further improved in an advantageous manner. In particular, the connecting element directed towards the housing part of the battery pack is designed to connect the battery pack to a guide unit of the consumer.

Furthermore, it is proposed that the connecting means comprises a locking element for locking the battery pack. As a result, the locking mechanism can be optimally adapted to the battery pack in an advantageous manner.

It is further proposed that the connecting means comprises a securing element for securing the battery pack in an unlocked state. As a result, the detachment process can be improved in an advantageous manner.

Alternatively, the disclosure relates in particular to a battery pack comprising a connecting means as described hereinabove, or a first connecting means comprising a connecting element directed towards the housing part of the battery pack, and a second connecting means comprising a locking element.

Furthermore, the disclosure relates alternatively in particular to an electric bike with a frame, whereby the frame comprises at least one tubular frame part which is designed to receive a battery pack with a connecting means, whereby the frame part comprises at least one guide element and/or at least one connecting element for the connecting means. The frame part can, e.g., be designed as a top tube, a seat tube, a down tube, or similar.

Alternatively, the disclosure relates in particular to a battery pack for an electric bike, whereby the battery pack is designed to be partially or completely accommodated within a frame part of the electric bike. It is proposed that the battery pack comprises a removal aid which is designed to support the removal of the battery pack from the frame part of the electric bike. As a result, it can be made easier to remove the battery pack from the electric bike.

The removal aid is preferably provided specifically for removing the battery pack and preferably has no other function, for example no means associated with the connection of the battery pack. The battery pack can comprise one or multiple removal aids that are arranged adjacent to and/or spaced apart from one another. The removal aids can in this case have the same or different designs.

It is further proposed that the removal aid is designed as an engagement recess. This allows a compact design of the battery pack to be achieved. The engagement recess can, e.g., be arranged as a depression in a surface of the battery pack, in particular a housing part of the battery pack. Alternatively, it is also conceivable that the removal aid is arranged essentially flat on a surface or is designed as an elevation on the surface.

It is further proposed that the removal aid comprises a surface structure in order to increase the roughness. As a result, the removal process can be further simplified in an advantageous manner. The surface structure can, for example, be designed as a plurality of elevations, in particular rib-shaped elevations. Alternatively or additionally, it is conceivable that the surface structure comprises a plurality of recesses, particularly groove-shaped recesses. However, the structures can also have a different shape, e.g. circular, oval, or rectangular. It is also conceivable that the surface structure is designed to be irregular. The surface structure can also be made of a material that differs from the housing, which has a higher grip and/or frictional force and thus has a higher adhesion for the fingers of a user. The removal aid is preferably ergonomically shaped, for example in the form of a finger-shaped engagement recess.

It is also proposed that the battery pack comprises a housing to which at least one connecting means is fastened for connection to the frame part of the electric bike, the connecting means having the removal aid. Advantageously, the removal aid can be arranged and designed specifically for the electric bike as required.

Furthermore, it is proposed that the removal aid is designed integrally with the connecting means. Alternatively, it is also conceivable that the removal aid is designed in one piece or in several pieces with connecting means and thus from a different material.

It is further proposed that the removal aid is arranged centrally in the connecting means. Alternatively or additionally, it is conceivable that the removal aid is arranged in the area of a fastening element receptacle.

### BRIEF DESCRIPTION OF THE DRAWINGS

Further advantages will become apparent from the following description of the drawings. The drawings, the description, and the claims contain numerous features in combination. The skilled person will appropriately also consider the features individually and combine them into additional advantageous combinations. Features of different embodiments are identified by the same reference sign and an additional letter identifying the embodiment. Unless otherwise described, the drawings are in this case shown to scale.

### Shown are:

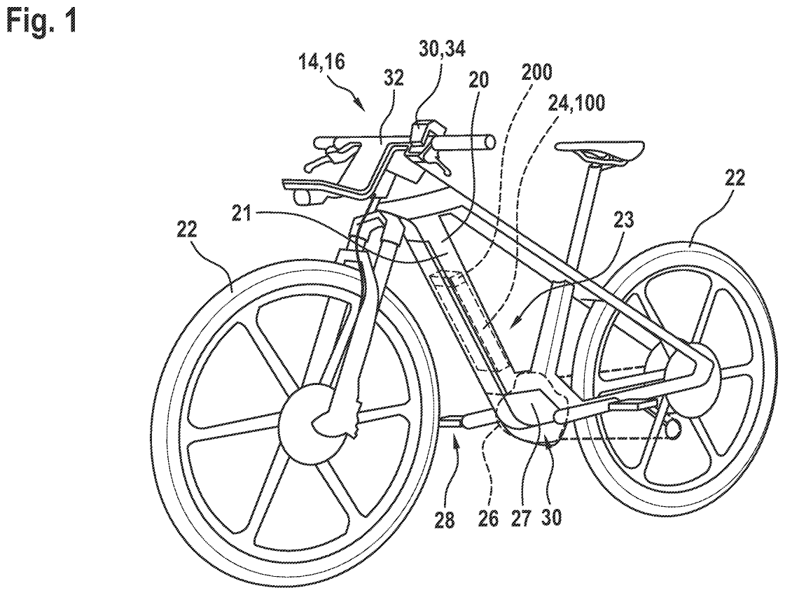

FIG. 1 a perspective view of an electric bike with a battery pack;

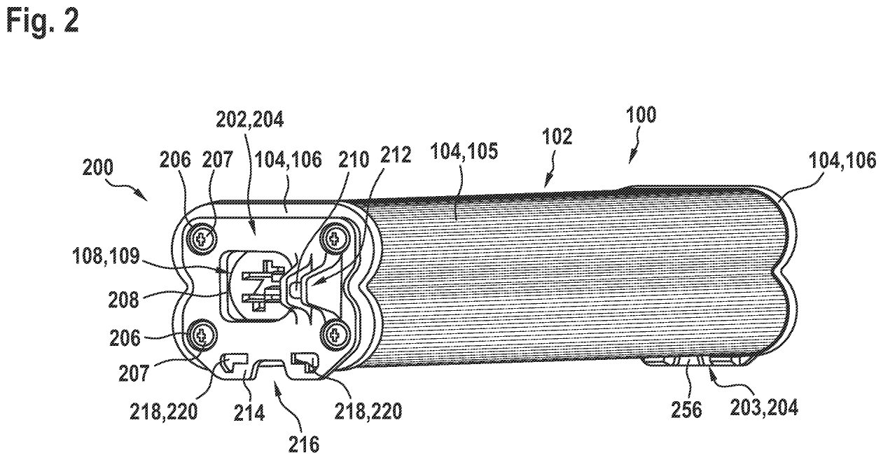

FIG. 2 a perspective view of a battery pack;

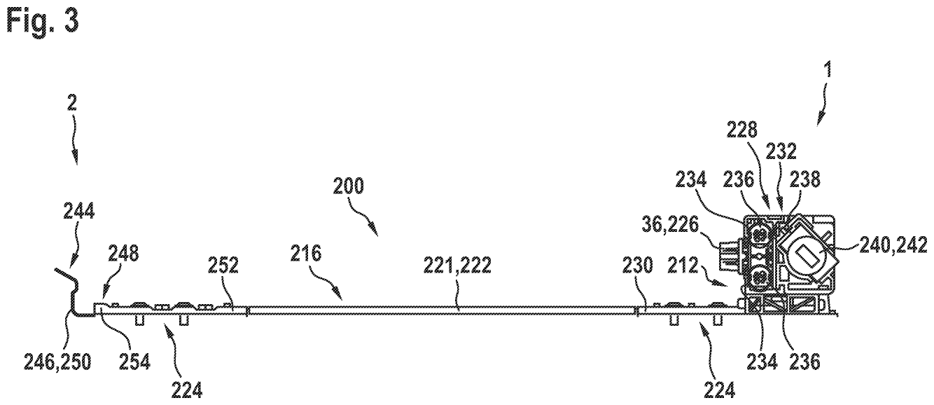

FIG. 3 a side view of a connecting device for the electric bike;

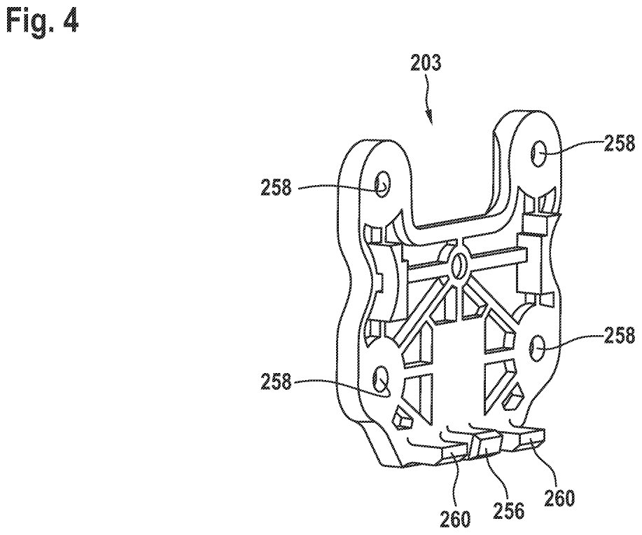

FIG. 4 a perspective rear view of a connecting means for the battery pack according to FIG. 2;

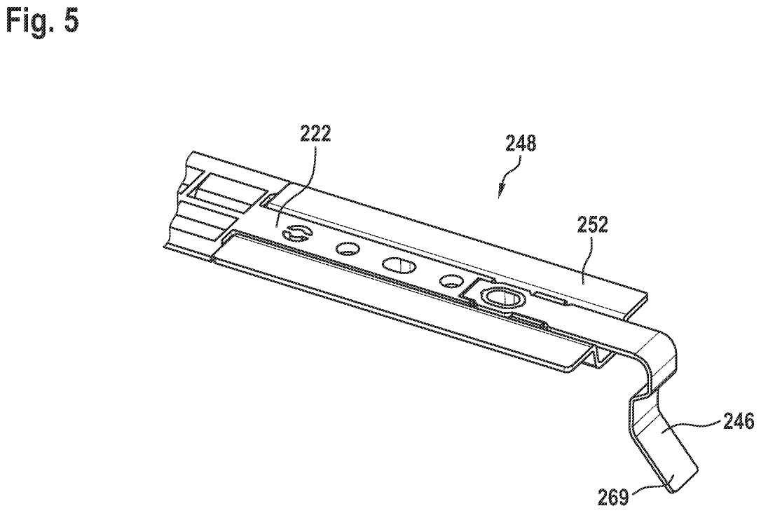

FIG. 5 a perspective rear view of a guide unit of the connecting device according to FIG. 3 in the second section;

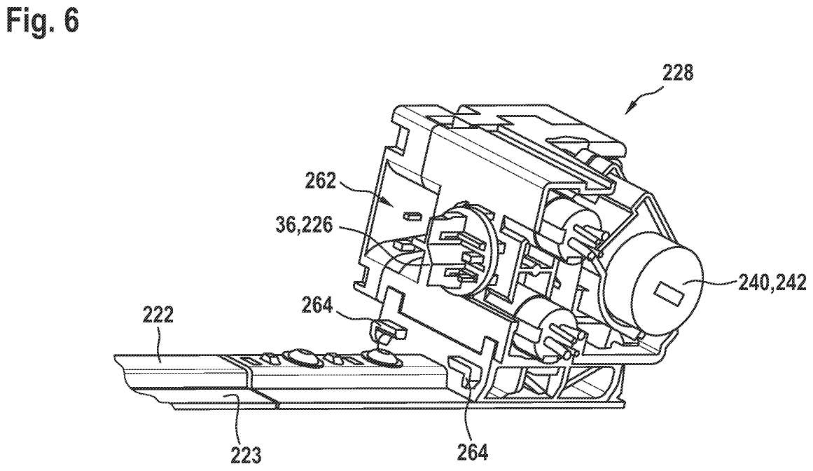

FIG. 6 a perspective view of the connecting device in the first section;

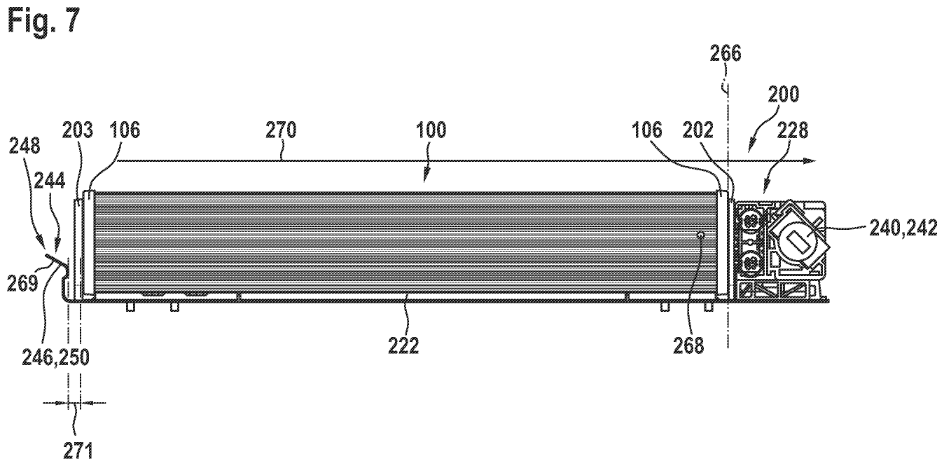

FIG. 7 a side view of the connecting device according to FIG. 3 in the connected and locked state with the battery pack according to FIG. 2;

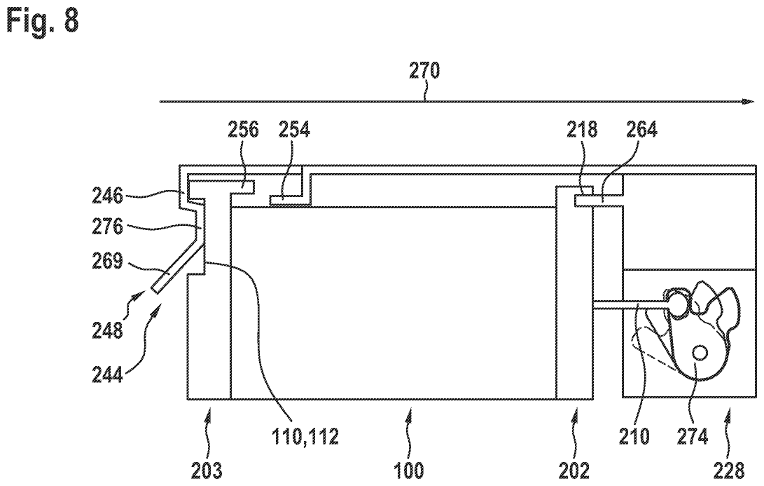

FIG. 8 a schematic view of the connecting device and the battery pack in an unlocked and secured state;

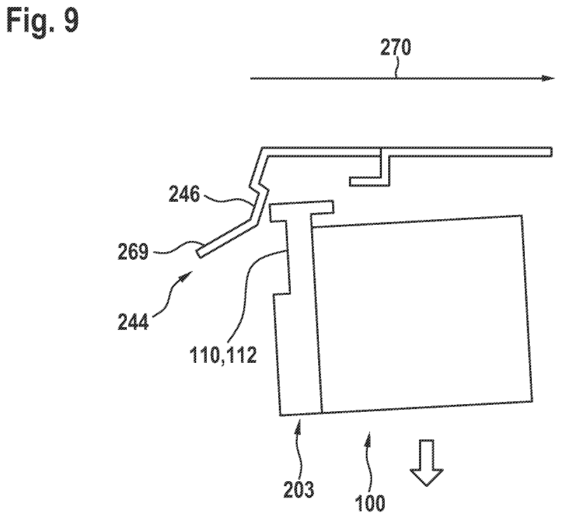

FIG. 9 a first removal option for the battery pack according to FIG. 7;

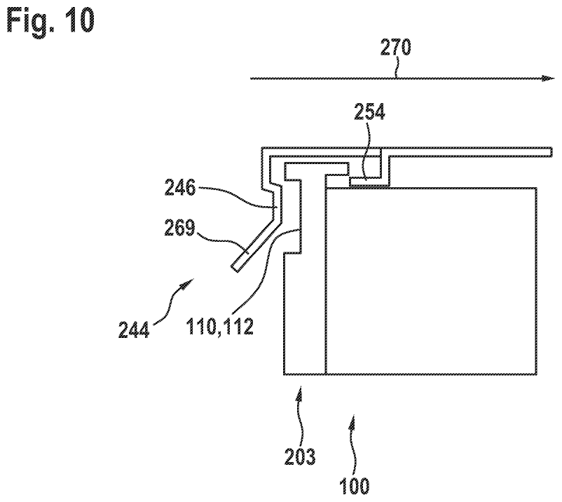

FIG. 10 a second removal option for the battery pack according to FIG. 7;

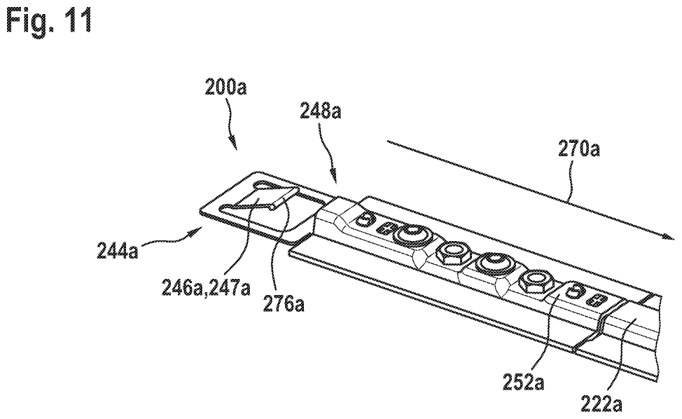

FIG. 11 an alternative embodiment of a securing unit for the connecting device according to FIG. 3;

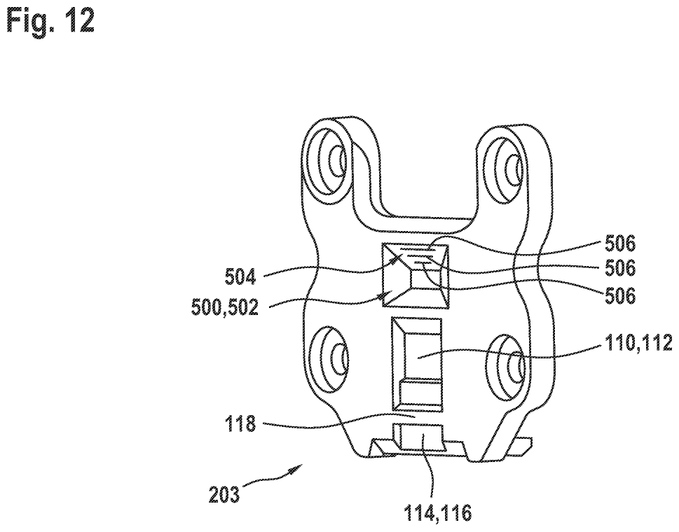

FIG. 12 a perspective front view of the connecting means according to FIG. 4;

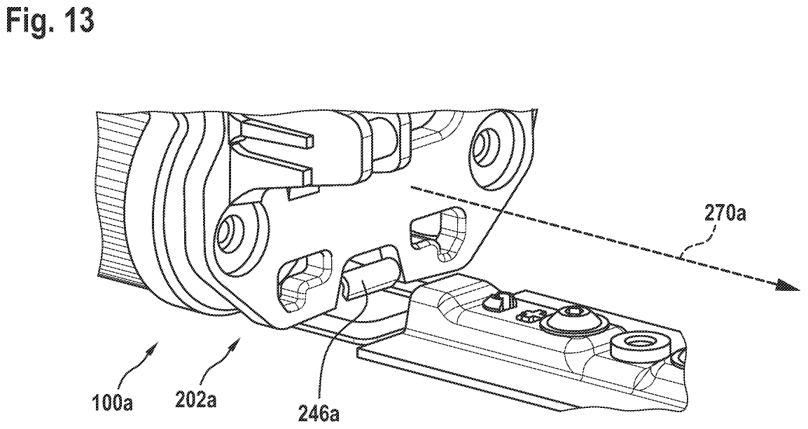

FIG. 13 a perspective view of a battery pack at the start of a connection process;

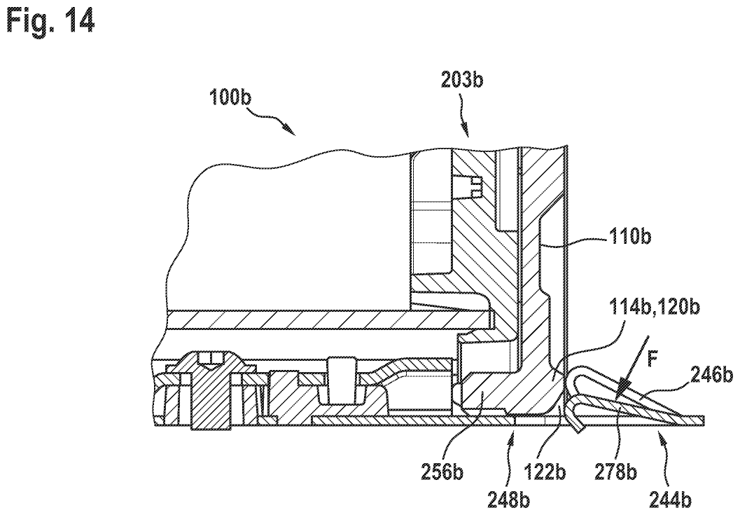

FIG. 14 a longitudinal section through the battery pack and the connecting device in the unlocked and secured state;

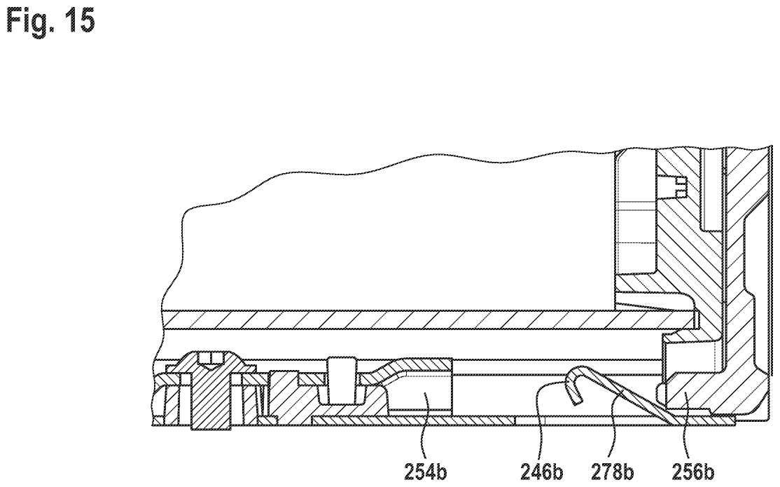

FIG. 15 a longitudinal section through the battery pack and the connecting device in the unlocked state after the securing mechanism has been released;

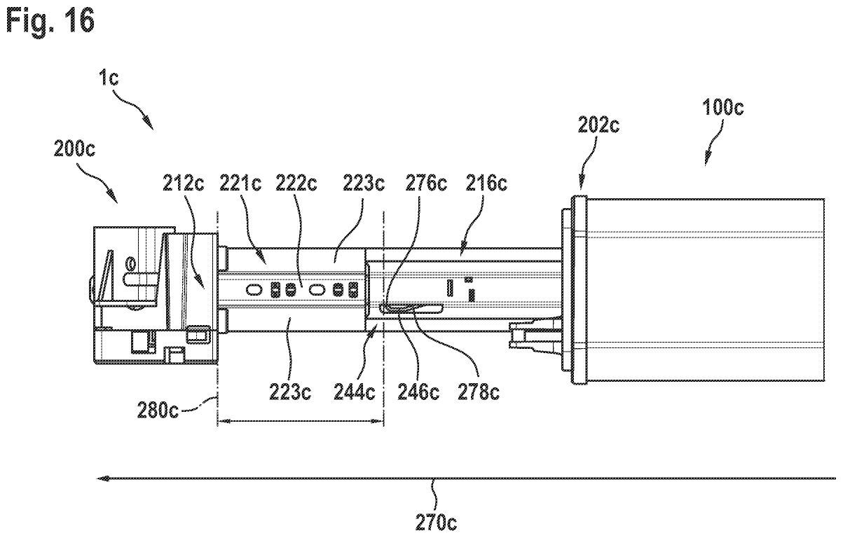

FIG. 16 a top view of a connecting device with a further alternative embodiment of a securing unit;

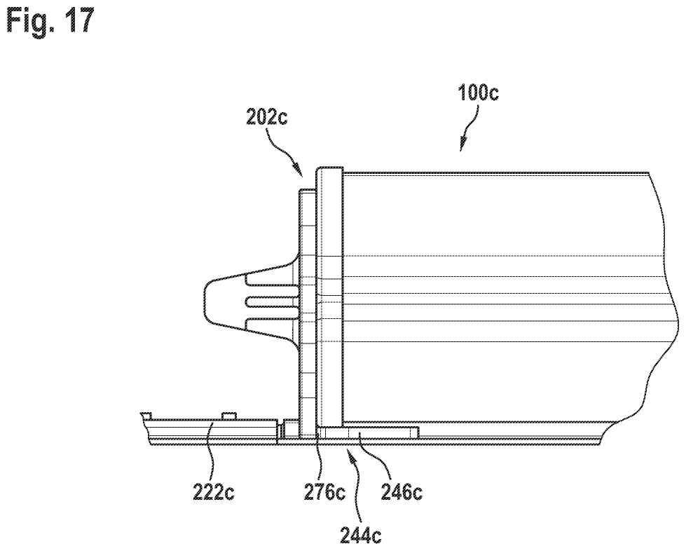

FIG. 17 a side view of a battery pack according to FIG. 2 in the state secured by the securing unit according to FIG. 16;

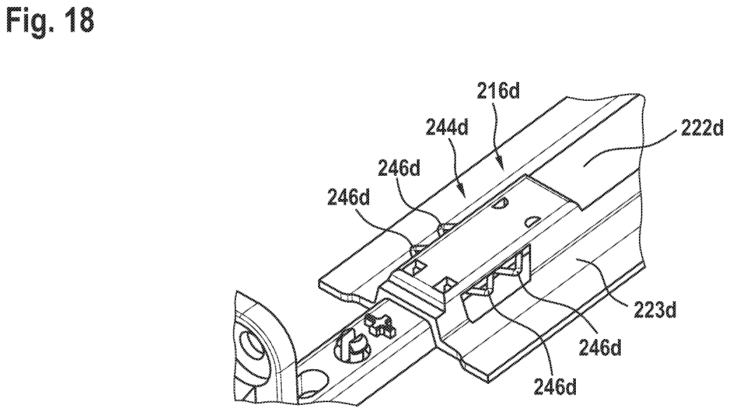

FIG. 18 a top view of a connecting device with a further alternative embodiment of a securing unit;

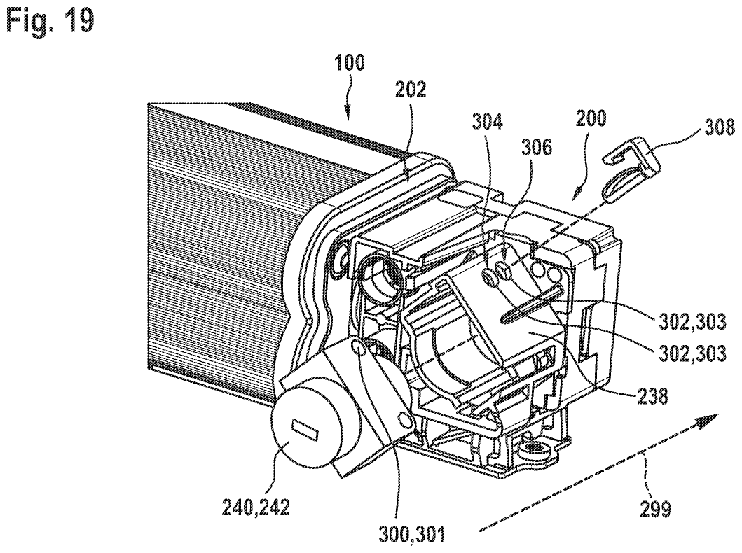

FIG. 19 a perspective view of a battery pack according to FIG. 2 in the state connected to the connecting device according to FIG. 6 with a receptacle housing of an actuating unit in an exploded view;

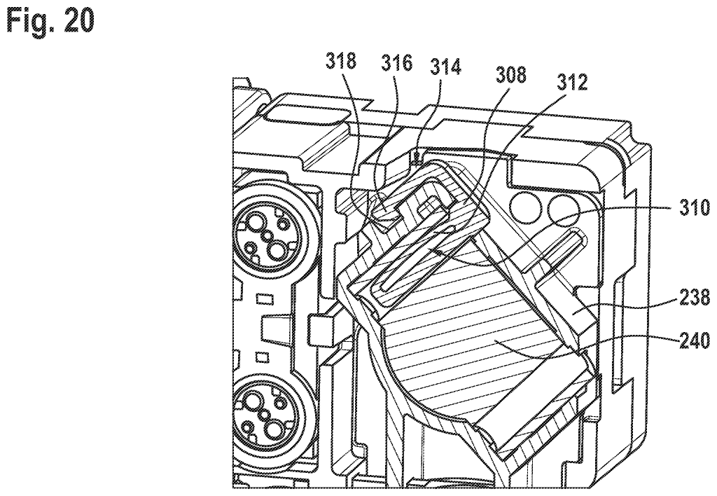

FIG. 20 a cross-section through the receptacle housing as shown in FIG. 19;

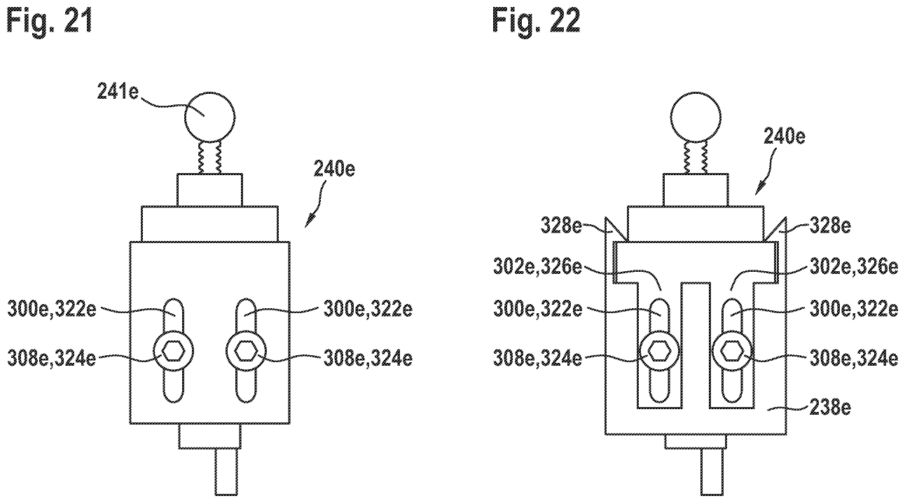

FIG. 21 an alternative embodiment of an actuating unit for a receptacle housing in a schematic view;

FIG. 22 an alternative embodiment of a receptacle housing for an actuating unit in the state connected to the actuating unit according to FIG. 21;

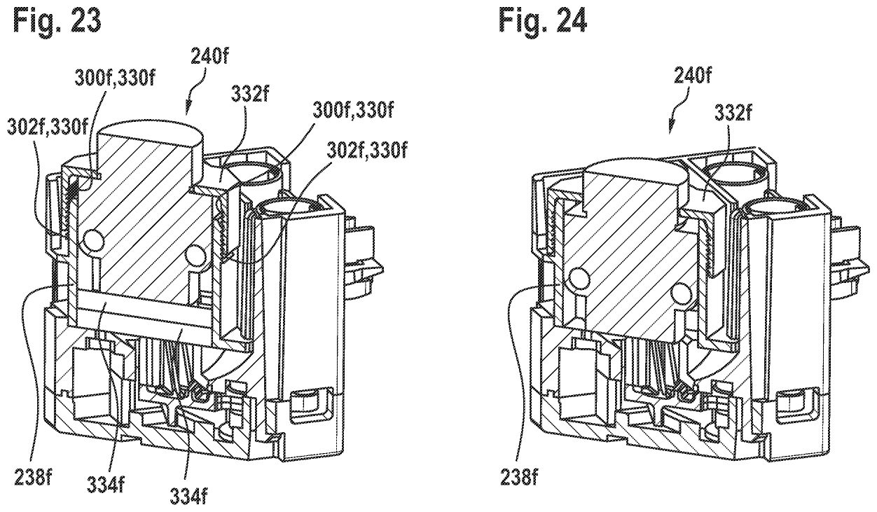

FIG. 23 a perspective view of a further embodiment of a receptacle housing with an actuating unit in a first position;

FIG. 24 a further embodiment of a receptacle housing with an actuating unit in a second position;

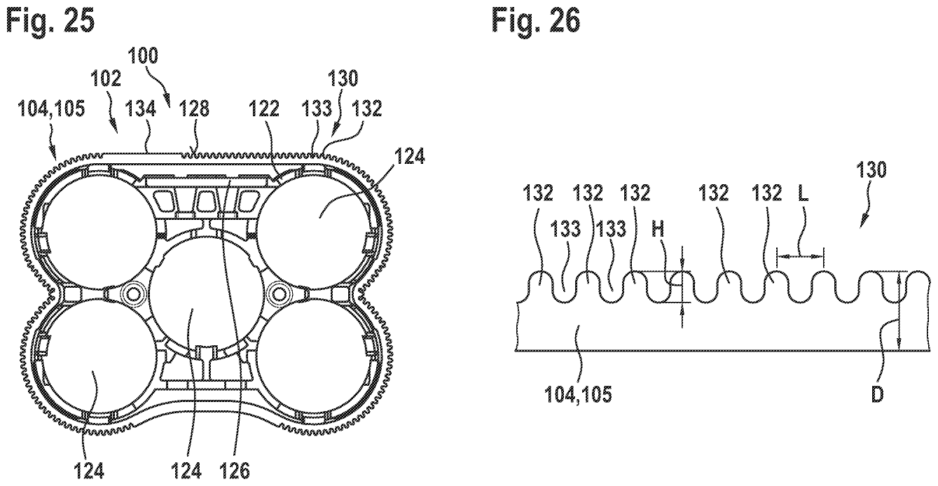

FIG. 25 a cross-section through a housing of the battery pack according to FIG. 2;

FIG. 26 an enlarged view of a section of the housing shown in FIG. 25;

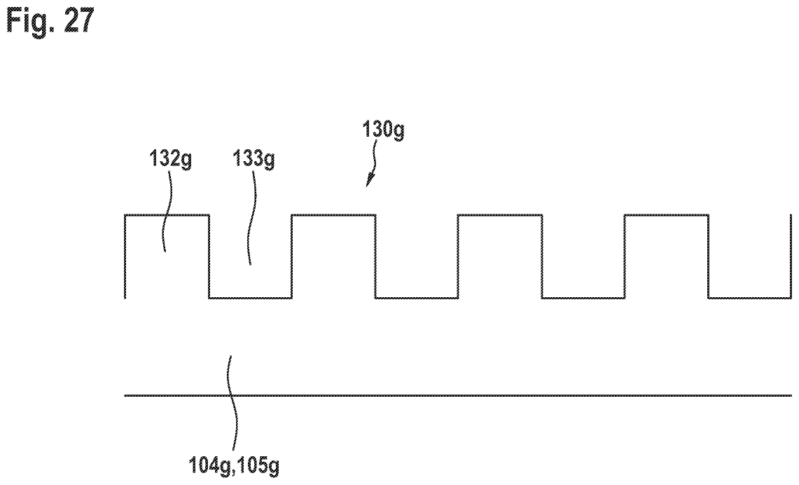

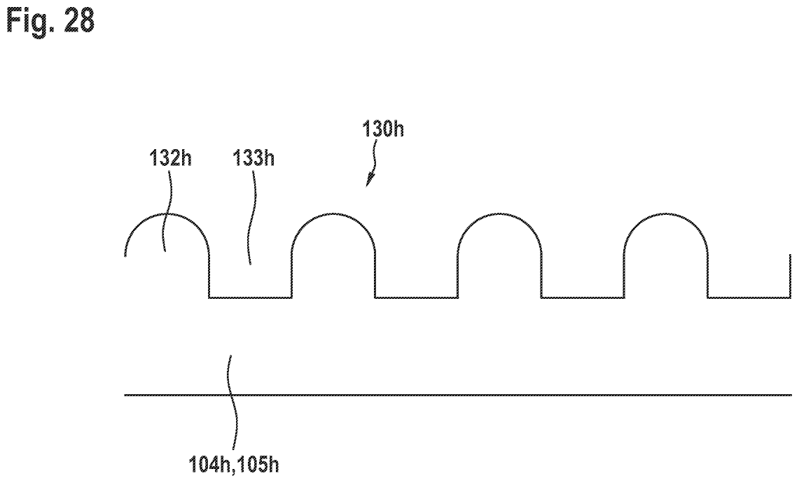

FIG. 27 a cross-section through an alternative ribbed structure for a battery pack housing;

FIG. 28 a cross-section of another alternative ribbed structure for a battery pack housing;

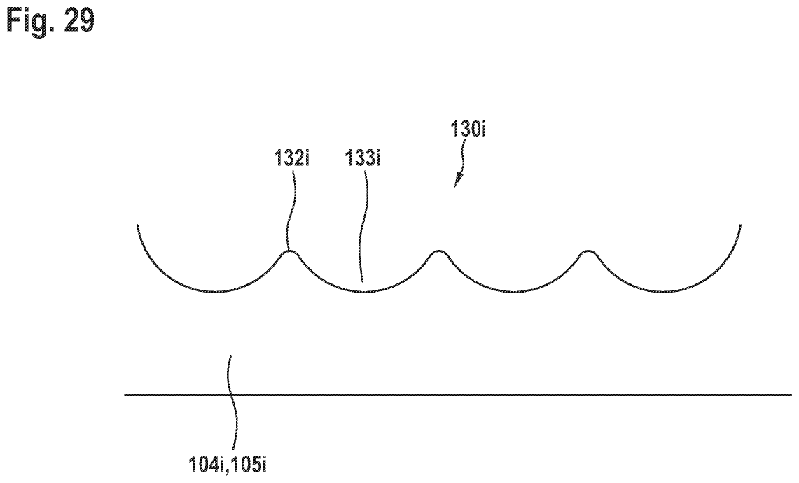

FIG. 29 a cross-section of another alternative ribbed structure for a battery pack housing;

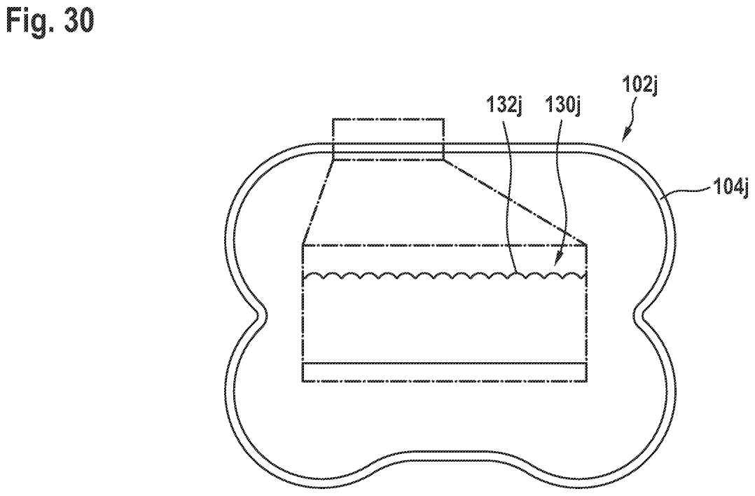

FIG. 30 a cross-section through a further alternative embodiment of a housing for a battery pack;

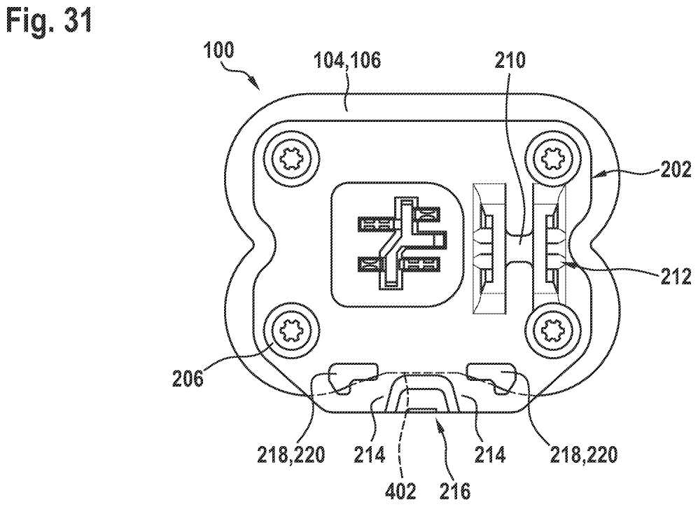

FIG. 31 a front view of the battery pack according to FIG. 2;

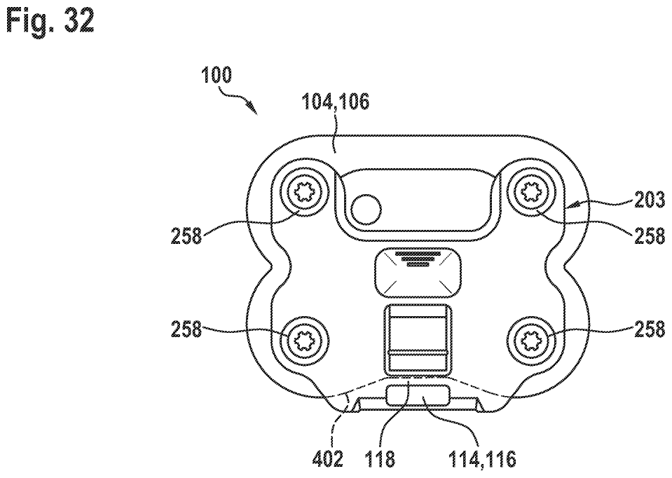

FIG. 32 a rear view of the battery pack according to FIG. 2;

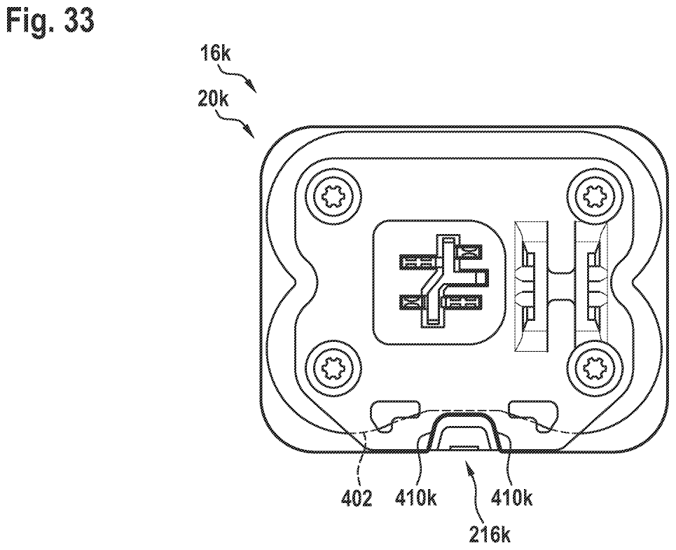

FIG. 33 a schematic illustration of an alternative embodiment of a frame of an electric bike for a connecting means according to FIG. 31;

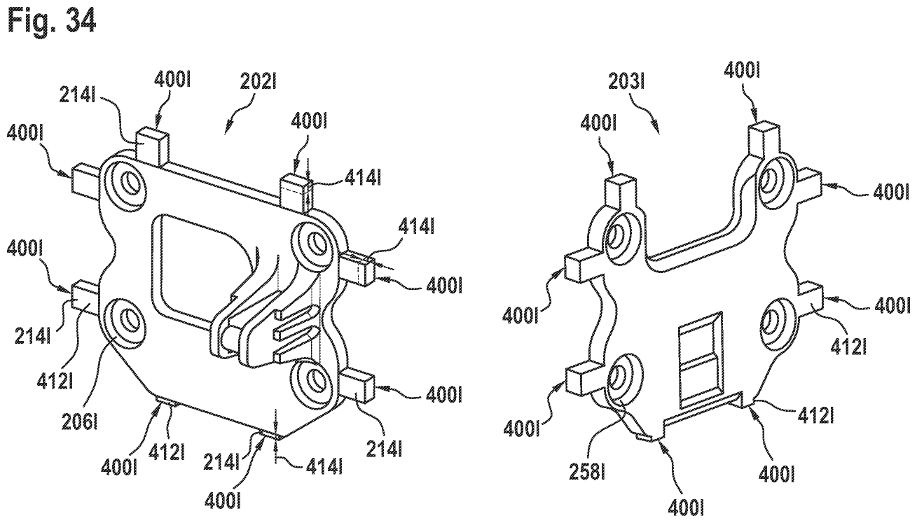

FIG. 34 perspective views of an alternative embodiment of the connecting means for the battery pack according to FIG. 2;

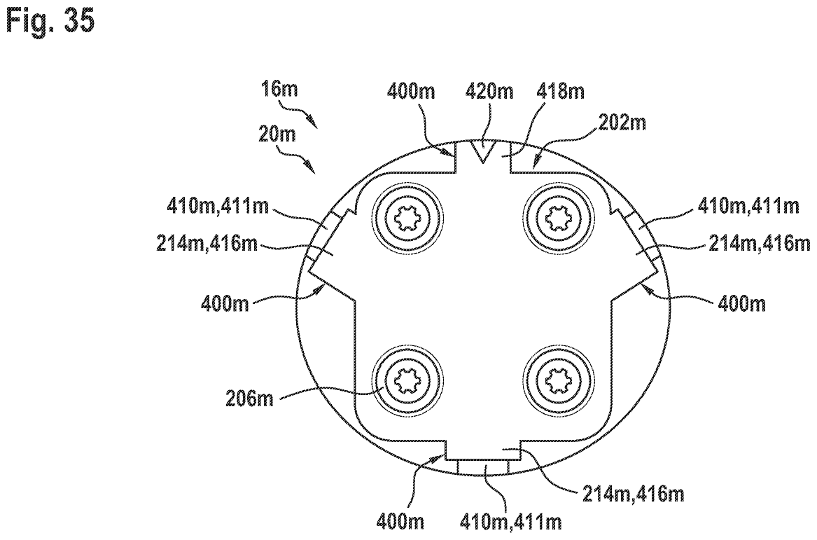

FIG. 35 a schematic view of a further alternative embodiment of a connecting means for a battery pack;

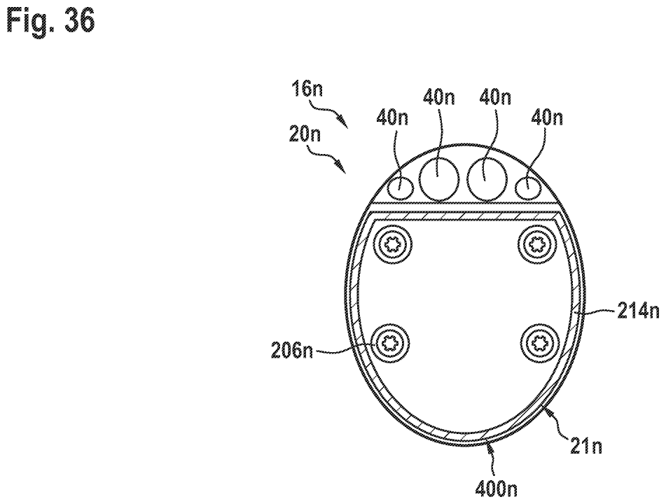

FIG. 36 a schematic view of a further alternative embodiment of a connecting means for a battery pack;

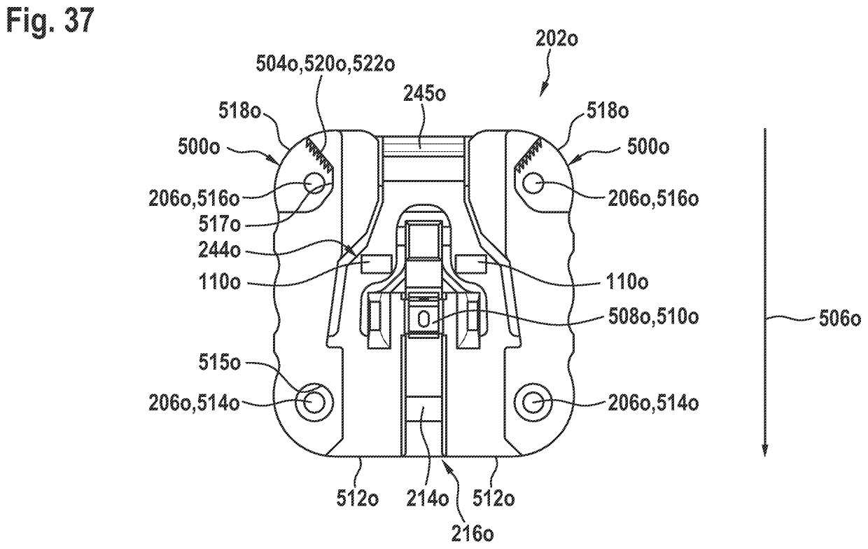

FIG. 37 a front view of a further embodiment of a connecting means for a battery pack comprising a removal aid;

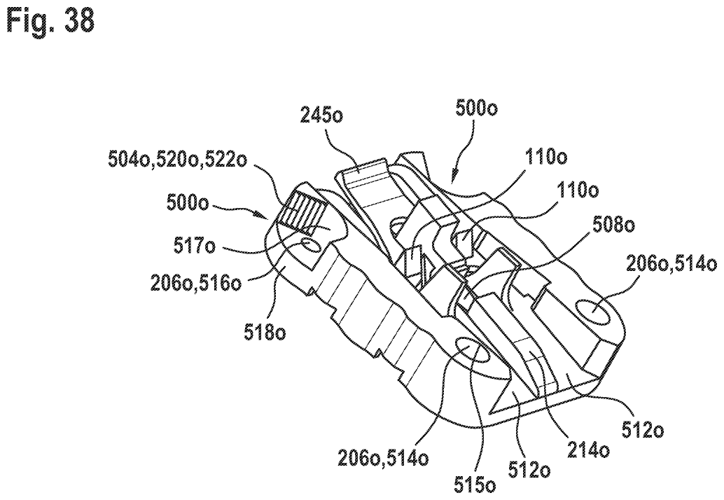

FIG. 38 a perspective view of the connecting means according to FIG. 37;

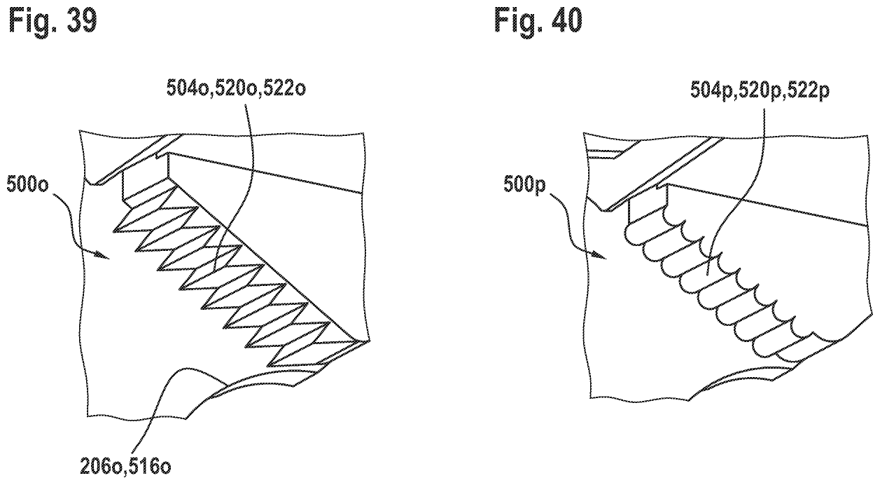

FIG. 39 an alternative embodiment of a surface structure of a removal aid;

FIG. 40 a further alternative embodiment of a surface structure of a removal aid;

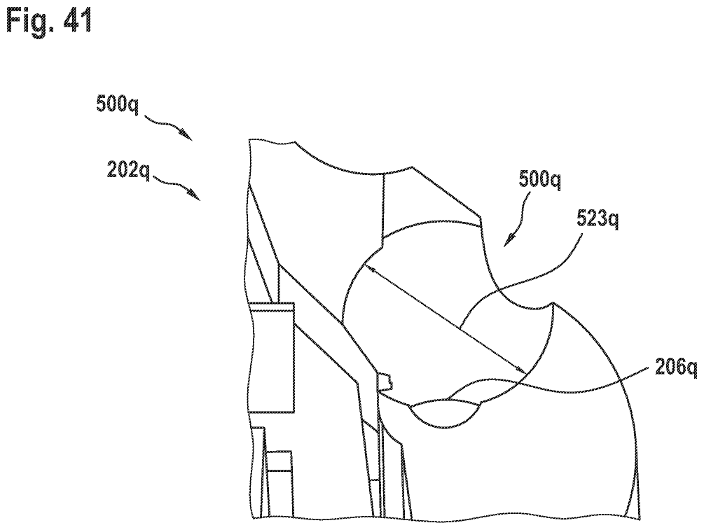

FIG. 41 a further alternative embodiment of a surface structure of a removal aid;

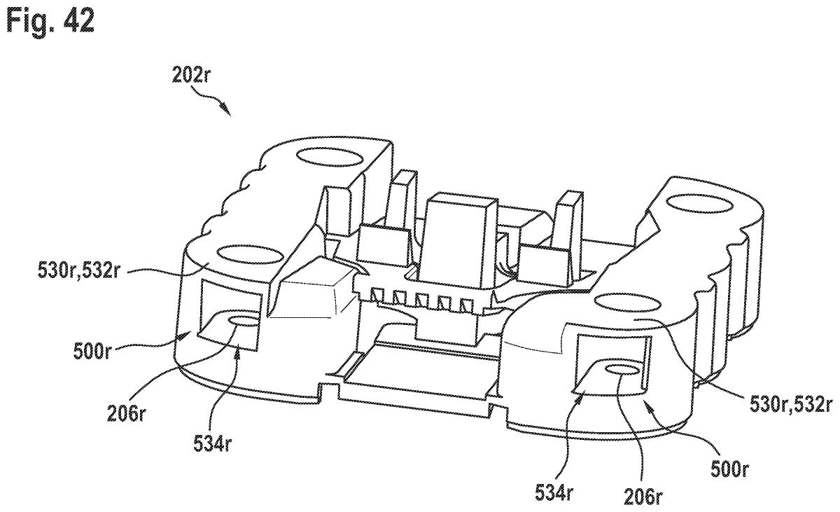

FIG. 42 a further alternative embodiment of a connecting means; and

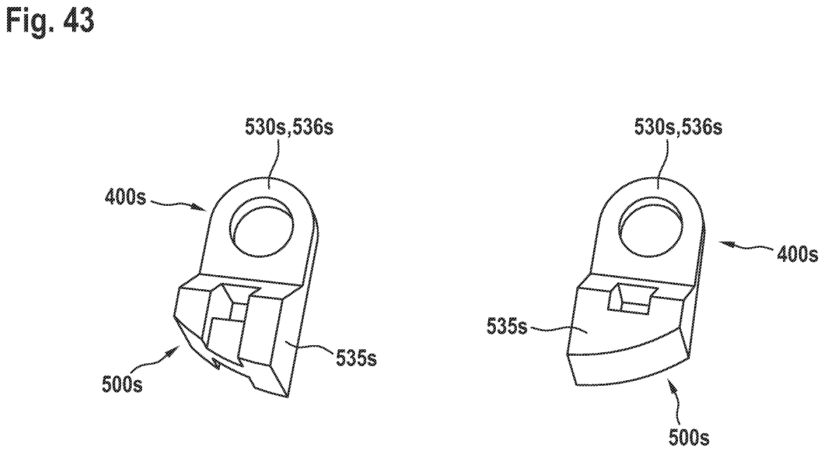

FIG. 43 a further alternative embodiment of a removal aid.

### DETAILED DESCRIPTION

FIG. 1 shows a perspective view of a consumer 14 in the form of an electric bike 16. The electric bike 16 can, e.g., be designed as a pedelec or an e-bike.

The electric bike 16 comprises a housing in the form of a frame 20 and/or a bike frame. Connected to the frame 20 are two wheels 22. The frame 20 comprises several frame parts, in particular a down tube 21, a top tube, and a seat tube. The electric bike 16 further comprises an energy storage means 24 in the form of a battery pack 100. In addition, the electric bike 16 comprises a drive unit 26, which comprises an electric motor or an auxiliary motor. The electric motor is preferably designed as a permanent magnet-excited, brushless DC motor. The electric motor is, e.g., designed, as a mid-drive motor, although a hub motor or the like is also conceivable. The electric bike 16, in particular the drive unit 26 of the electric bike 16, is powered via the energy storage means 24. The battery pack 100 is, e.g., designed to be integrated into the frame 20. The battery pack 100 is designed as an exchangeable battery pack, which can be releasably connected to the electric bike 16 via a connecting device 200.

The drive unit 26 comprises a control unit (not shown) designed to control or regulate the electric bike 16, in particular the electric motor. The electric bike 16 comprises a pedal crank 28. The pedal crank 28 comprises a pedal crankshaft (not shown). The control unit of the electric bike 16 is connected to a sensor unit (not shown). The sensor unit of the electric bike 16 comprises, e.g., multiple sensor elements, such as a torque sensor, a motion sensor, e.g., in the form of an acceleration sensor, and a magnetic sensor.

The control unit and the drive unit 26 having the electric motor and the pedal crankshaft are arranged within a drive housing 27 connected to the frame 20. The drive movement of the electric motor is preferably transmitted to the pedal crankshaft via a transmission (not shown), whereby the magnitude of the assistance by the drive unit 26 is controlled or regulated via the control unit. The control unit is designed to drive the drive unit 26 such that the rider of the electric bike 16 is assisted in pedaling. Preferably, the control unit is designed such that it can be operated by the rider so that the rider can set the assistance level.

The control unit and the sensor unit are associated with the electronic system (not shown) of the electric bike 16. The electronic system comprises, e.g., a printed circuit board on which are arranged a computing unit in the form of a CPU, a memory unit, and the sensor unit. The electronics are, by way of example, arranged entirely within the drive housing 27 of the drive unit 26. However, it is also conceivable that the electronics be only partially arranged in the drive housing 27 and that components of the electronics be arranged in other areas of the electric bike 16. In addition, an arrangement of the electronics outside the drive housing 27 is also conceivable.

The electric bike 16 also comprises, e.g., an on-board computer 30 arranged on a handlebar 32 of the electric bike 16. The on-board computer 30 is partially designed to be releasably connected to the electric bike 16. The on-board computer 30 comprises a display unit 34 designed to display information. The on-board computer 30 also comprises an operating element (not shown), via which the user or the rider can control the onboard computer 30 and/or the electric bike 16. The operating element is, by way of example, designed as a touchscreen. It is also conceivable, however, that the control element of the on-board computer 30 be made of buttons or knobs. The on-board computer 30 is connected to the control unit of the electric bike 16 such that information can be exchanged. For example, the display unit 34 can display a speed determined by the control unit, a set assistance level of the electric motor, route information of a navigation unit, and a state of charge of the energy storage means 24.

By way of example, the battery pack 100 is arranged in the down tube 21 of the frame 20. The down tube 21 in this case comprises a receptacle shaft 23, in which the battery pack 100 is arranged essentially completely in the connected state. The battery pack 100 is thereby swivelled into the down tube 21 for connection. The connection is made via the connecting device 200, which is, by way of example, fully installed in the frame 20. It is also conceivable that the connecting device 200 is only partially installed in the frame 20 of the electric bike 16.

FIG. 2 shows a perspective view of the battery pack 100 accommodated in the frame 20 of the electric bike 16. The battery pack 100 comprises a housing 102 which, by way of example, comprises three housing parts 104. In the housing 102 of the battery pack 100, 20 battery cells (not shown) are arranged as an example, which are electrically connected to each other via a series and parallel circuit to form a 36V battery pack. The battery pack 100 further comprises a battery management system (not shown) designed to control and monitor the battery pack 100, whereby the battery management system is arranged within the housing 102 of the battery pack 100. The housing 102 comprises a central housing part 105 which is, by way of example, formed in an tubular shape, with a cross-section adapted to the battery cells accommodated. The central housing part 105 is designed integrally and extends essentially along the entire length of the battery pack 100. At the front, the housing 102 comprises two housing parts 104 designed as end plates 106. The end plates 106 are, by way of example, connected to the central housing part 105 by means of a laser transmission welding process. Alternatively, other types of connection, such as a screw connection, are also conceivable.

The connecting device 200 for connecting the battery pack 100 to the electric bike 16 comprises components on the battery pack side that are associated with the battery pack 100 and components on the bike side that are associated with the electric bike 16. In this context, the term “associated with” should be understood to mean that the component is fastened to the battery pack 100 or to the electric bike 16 during normal use.

The connecting device 200 comprises, by way of example, two components on the battery pack side. Alternatively, only one battery pack-side component or several battery pack-side components would also be conceivable. The components on the battery pack side are, by way of example, designed as connecting means 202, 203. The connecting means 202, 203 are, by way of example, designed in the form of connecting plates 204, which are fastened to the end plates 106 of the battery pack 100. The fastening is in this case performed using a screw connection, although other frictional and/or interlocking connections, or a bonded connection, are also conceivable. It is also conceivable that the connecting means 202, 203 is designed integrally or in one piece with the housing 102 of the battery pack 100. For example, it is conceivable that the end plates 106 are designed as connecting means 202, 203 and assume their function.

The connecting means 202, 203 are in this case designed differently and differ in particular in their functions. The first or front connecting means 202 is arranged at the end plate 106 of the battery pack 100, which comprises the electrical interface 108 of the battery pack 100. The electrical interface 108 of the battery pack 100 is designed for the electrical connection of the battery pack 100 to the electric bike 16, in particular for power supply and/or information exchange. The electrical interface 108 of the battery pack 100 comprises, by way of example, a socket 109.

The connecting means 202, 203 are, by way of example, designed integrally. The connecting means 202, 203 are, by way of example, also made of a plastic, in particular a hard plastic.

The connecting means 202 comprises, by way of example, four fastening element receptacles 206, which are designed for fastening the connecting means 202 to the housing 102 of the battery pack 100, in particular to the end plate 106. The fastening element receptacles 206 are, by way of example, designed as circular recesses for screws 207.

The connecting means 202 further comprises a through-opening 208 in the area of the electrical interface 108 of the battery pack 100 in order to enable an electrical connection to a corresponding electrical interface of the electric bike 16.

Furthermore, the connecting means 202 comprises a locking element 210 of a locking unit 212 for releasably locking the battery pack 100 to the electric bike 16, a guide element 214 of a guide unit 216 for guiding the battery pack 100 during the connection process with the electric bike 16 and two, by way of example, L-shaped recesses 218 for centering the battery pack 100. The L-shaped recesses 218 are also designed as linear bearing elements 220, which support the battery pack 100 in connected state and absorb the forces that occur in the event of vibrations.

FIG. 3 shows a side view of the components of the connecting device 200 on the bike side. The components of the connecting device 200 on the bike side comprise, by way of example, a guide element 221 in the form of a guide rail 222 with adjacent guide grooves 223 (see, for example, FIG. 6), which is associated with the guide unit 216 of the connecting device 200. The guide rail 222 is, e.g., fastened to the frame of the electric bike 16 by means of a screw connection 224.

In addition, the connecting device 200 comprises a connector 226, which is assigned to an electrical interface 36 of the electric bike 16 and corresponds to the electrical interface 108 of the battery pack 100. The connector 226 is releasably connected to the guide unit 216. The electrical interface 36 of the electric bike 16 is fastened to the frame 20 of the electric bike 16 by means of a multi-piece connecting means 228. The fastening in this case is, e.g., performed via a screw connection, in particular via the same screw connection 224 that is also used for the guide rail 222. The connecting means 228 comprises a guide element 230, which is designed such that the guide contour of the guide rail 222 is continued. The guide element 230 of the connecting means 228 is made of a metal. Alternatively, it would also be conceivable to form the guide element 230 from a plastic.

The connecting means 228 also comprises a housing unit 232, which can optionally be mounted in various configurations, or as an alternative to other housing modules (not shown). The connector 226 is releasably connected to the housing unit 232. In particular, the housing unit 232 is also designed for other connectors, so that the connecting device 200 can also be adapted for other battery packs. Alternatively or additionally, the housing unit 232 can also be installed in a different configuration, e.g. rotated by 90°. The connecting means 228 also comprises a movably mounted locking element 274 (see FIG. 8) which is associated with the locking unit 212 of the connecting device 200. The locking element 274 is arranged in the housing unit 232. In addition, the housing unit 232 comprises, by way of example, two connector receptacles 234 for receiving further connectors 236 of the electric bike 16, via which the battery pack 100 can be electrically connected to further components of the electric bike 16 via cable elements.

The housing unit 232 further comprises a receptacle housing 238 for an actuating unit 240. The receptacle housing 238 is preferably designed such that it can be mounted in different configurations or orientations. The actuation unit 240 is designed to actuate the locking unit 212, whereby a lock between the battery pack 100 and the electric bike 16 can be released by actuating the actuation unit 240. The actuating unit 240 is, by way of example, designed as a lock 242, which can be actuated via a key 241 (see, e.g., FIG. 21). The actuating unit 240 is mechanically coupled to the locking unit 212.

In addition, the connecting device 200 comprises a securing unit 244, which is designed to secure the battery pack 100 in the unlocked state. The securing unit 244 comprises a securing element 246 which is arranged on a further connecting means 248, the further connecting means 248 being arranged, by way of example, on an opposite side of the guide rail 222 with the latter likewise via a screw connection. The securing unit 244 is designed to secure the battery pack 100 in the unlocked state. The securing element 246 is, by way of example, designed as a metallic leaf spring 250.

Similar to the connecting means 228, the further connecting means 248 also comprises a guide element 252, which corresponds to the guide rail 222. In addition, the connecting means 248 comprises a retaining element 254 on the end face, whereby the battery pack 100, in particular a connecting means 202 of the battery pack 100, is held in the locked state by the retaining element 254. The retaining element 254 is designed as an opening on the end face, which has an essentially U-shaped cross-section.

The locking unit 212 is arranged on a first section 1, in particular on a front section, of the guide unit 216. The securing unit 244 is arranged on a second section 2, in particular on a rear section, of the guide unit 216. In the first section 1, a distance to the locking unit 212 is smaller than a distance to the securing unit 244. As described in this embodiment, the guide unit 216 can have several guide elements or alternatively only a single guide element. The length of the guide unit 216 essentially corresponds to the greatest possible distance between the furthest guide elements. The length of the guide unit 216 essentially corresponds, by way of example, to the length of the battery pack 100. However, it is also conceivable that the battery pack 100 is only routed over a small area, for example only 10% of its length or less. The first section 1 and the second section 2 of the guide unit 216 extend in particular from the different ends of the guide unit 216.

In FIG. 4, the second or rear connecting means 203 of the battery pack 100 is shown in a perspective view with an engagement means 256 corresponding to the retaining element 254. Similar to the first connecting means 202 of the battery pack 100, the connecting means 203 comprises four fastening elements 258 in the form of screw receptacles for screws, which are provided for connection to the corresponding end plate 106 of the battery pack 100. The retaining element 254 in this case extends in the direction of the battery pack 100 below the housing 102 of the battery pack 100. Adjacent to the retaining element 254, the connecting means 202 comprises two further retaining elements 260, which are provided in particular to counteract tilting of the battery pack 100 about the longitudinal axis of the battery pack 100 in connected state. In addition, the engagement means 256 is aligned during insertion such that it engages centrally in the retaining element 254. This is achieved in particular by the additional retaining elements 260, which are slightly longer and comprise additional demolding chamfers.

In FIG. 5, the further connecting means 248 connected to the guide rail 222 is shown in a perspective view, starting from the frame 20 or from below. The further connecting means 248 is, by way of example, designed such that the securing element 246 of the securing unit 244 and the guide element 252 of the guide unit 216 can be connected independently of one another to the guide rail 222 and/or the frame 20 of the electric bike 16. The guide element 252 is connected to both the guide rail 222 and the frame 20 via the screw connection 224. The securing element 246 is connected directly only to the guide rail 222 by means of a force-fit and form-fit connection, for example by clamping.

In FIG. 6, the connecting means 228 of the connecting device 200 is shown in a perspective view. The movable locking element 274 is arranged in a receptacle 262 for the corresponding locking element 210 on the connecting plate 204 of the battery pack 100. The connecting means 228 further comprises two linear bearing elements 264, which extend in the direction of the battery pack 100 starting from a first connecting plane 266 (see FIG. 7), at which the connecting means 228 of the consumer 14 and the connecting means 202 essentially rest against each other in the locked state, and are correspondingly L-shaped in cross-section. Alternatively, other geometries, such as rectangular or square, are also conceivable.

FIG. 7 shows a side view of the connecting device 200 with the battery pack 100 in the locked state.

For connection, the battery pack 100 is first swivelled in relative to the electric bike 16 about a connection axis 268. The connecting axis 268 is in this case shown at one point for illustration purposes, whereby the swivelling can also take place in an adjacent area depending on the tolerance. When swivelled in, the outwardly projecting locking element 210 of the battery pack 100 is inserted into the corresponding receptacle 262 of the connecting device 200 in the frame 20 of the electric bike 16. In addition, the electrical interface can already be partially connected.

After the battery pack 100 has been inserted into the frame, the battery pack 100 rests on the guide rail 222 and can be displaced in the direction of the connecting means 228 by a linear movement in the connecting direction 270. The relative movement in the direction of the connecting means 228 triggers the locking unit 212 and locks the battery pack 100 to the electric bike 16. In addition, the socket 109 of the battery pack 100 is connected to the connector 226 of the electric bike 16. The mobility of the battery pack 100 along the connecting direction 270 is limited by the connecting means 228 and the securing element 246. However, the securing element 246 is elastically designed and can be moved against the connecting direction 270 by applying a force to the securing element 246 such that a range of movement 271 can be slightly enlarged along the connecting direction 270. The force on the securing element 246 can be applied directly by the user via the actuation area 269, which is designed integrally with the securing element 246.

The lock can be released by actuating the actuating unit 240. By way of example, the actuating unit can be actuated manually by inserting the key into the slot provided for this purpose in the lock 242. For example, by turning the key in the lock 242, the locking mechanism is released and the locking element movably mounted in the connecting means 228 is actuated such that the battery pack 100 is ejected in the opposite direction to the connecting direction 270.

FIG. 8 shows a schematic view of the battery pack with the connecting device 200 in the unlocked but connected state. The movably mounted locking element 274 is biased against the connecting direction 270 by a spring element (not shown), so that the battery pack 100 is pushed out of the connecting means 228 against the connecting direction 270 during the transition from the locked state to the unlocked state until the battery pack 100 strikes the securing element 246 of the further connecting means 248. The securing unit 244 thus essentially provides a secondary locking mechanism. For this purpose, an area of the securing element 246 is designed as a stop element 276. In particular, the battery pack 100, in particular the connecting means 203 of the battery pack 200, comprises a corresponding securing element 110, e.g. in the form of a rectangular recess 112, in which the stop element 276 engages in the connected or unlocked state. Advantageously, the securing unit 244 ensures that the battery pack 100 does not fall out of the frame 20 of the bike unintentionally when the locking mechanism is released. It is initially not possible to release the connection by swivelling out in this state. The connecting device 200 is, by way of example, designed such that the user has two options for releasing the connection.

The first option is shown in FIG. 9 in a schematic view. For this purpose, the user presses with a force on the actuation area 269 of the securing element 246 and thus displaces the securing element 246 against the connection direction 270 and thus increases the range of movement 271 of the battery pack 100 in the connected state. By means of the enlarged range of movement 271, the battery pack 100 can be detached from the electric bike 16 and removed.

The second option for removing the battery pack 100 is shown in FIG. 10 in a schematic view. For this purpose, the battery pack 100 is moved by a user a short distance in the connecting direction 270 and against the spring force of the spring element of the rotatably mounted locking element 274 such that neither the securing element 246 nor the retaining element 254 of the connecting means 248 forms a frictional and/or interlocking connection with the battery pack 100, in particular the connecting means 203 of the battery pack 100, and thus the battery pack 100 can be swivelled out.

It is also conceivable that the connecting device 200 is designed such that only one of these possibilities exists. For example, by a non-movable securing element 246 or by an arrangement of the securing element 246 and the retaining element 254 which is designed such that release is only possible by actuating the securing element 246.

The connecting device 200 described from FIG. 1 to FIG. 10 is designed to connect the battery pack 100 via a swivel movement into the frame 20, e.g. into the down tube of the frame 20. Following the swivel movement, this is supplemented by a linear movement along the connection direction 270 in order to mechanically and electrically connect and lock the battery pack 100 to the electric bike 16. The frame 20 comprises a side opening (not shown) for this purpose, e.g. on the underside. In particular, the length of this opening essentially corresponds to the length of the battery pack 100.

In FIG. 11, an alternative embodiment of the previously described securing unit 244 is shown in a partial perspective view. This alternative embodiment is intended for frames of electric bikes in which the battery pack 100 is not swivelled in sideways, but only pushed in linearly. This can, e.g., be performed by opening the frame in the area of the drive unit. Advantageously, with the adapted securing unit 244, the connecting device 200 can be made without further adjustments in the area of the connecting means 202, 203 on the battery pack 100 and without adjustments to the front connecting means 228.

The securing unit 244a comprises an alternative securing element 246a which, as described hereinabove, is associated with a connecting means 248a which is connected to a guide rail 222a. As described hereinabove, the connecting means 248a comprises a guide element 252a for guiding the battery pack 100 along or against the connection direction 270a during the connection process.

The securing element 246a is, by way of example, made of metal, whereby it is also conceivable to manufacture the securing element 246a from another material, e.g. from plastic. The securing element 246a is designed as a resilient stop 247a and comprises a stop element 276a. The stop element 276a is, by way of example, arranged at a tip of the securing element 246a. The securing element 246a is designed such that the stop element 276a can be moved downwards, in particular in the direction of the guide rail 222a, by applying a force transverse to the connecting direction 270a.

FIG. 12 shows a perspective view of the connecting means 203 of the battery pack 100, which is provided for connection to the securing unit 244a in the unlocked state.

In addition to the already described securing element 110, which is arranged essentially centrally in the connecting means 203, the connecting means 203 comprises a second securing element 114. The second securing element 114 is provided for the securing element 246a of the alternative securing unit 244a. Advantageously, the connecting means 203 can thus be used for both securing units 244, 244a and the battery pack 100 can thus be adapted as required. The second securing element 114 is also, by way of example, designed as a rectangular recess 116. The first securing element 110 and the second securing element 114 are, by way of example, separated from each other by a partition 118. The partition 118 forms an additional counter-contour at least for the securing element 246a of the alternative securing unit 244a.

In FIG. 13, the battery pack 100 is shown at the beginning of the connection process, in which the battery pack 100 is pushed into the frame of the electric bike with the connecting means 202a in front. The securing element 246a is designed such that it has a smaller height than the guide rail 222a, even when no force is applied and is therefore lower than the guide rail 222a. The battery pack 100 can therefore be inserted without additional force. However, it is also conceivable that the securing element 246a is higher and is pressed down by the battery pack 100 during the connection process. The stop element 276a preferably comprises a rounded stop surface to make it easier to release the securing mechanism. The release can be done manually by the user directly actuating the securing element 246a with a finger or indirectly via the battery pack 100 when applying a force against the connection direction 270a.

FIG. 14 shows an alternative embodiment of the connecting means 203b in a longitudinal section in an unlocked and secured state. The connecting means 248a of the electric bike corresponds to the previously described connecting means 248a with the alternative securing unit 244a.

Similar to the previous embodiment, the connecting means 203b comprises a first securing element 110b and a second securing element 114b. The second securing element 114b differs in that the second securing element 114b is designed as a flat stop surface 120b, which is arranged adjacent to a slope 122b, along which the securing element 246a is guided when the securing device is released.

In FIG. 15, the connecting means 203b is shown in a longitudinal section at the start of the connection process. Whereas the front connecting means 202 can be connected in the area of the electrical interface 108 of the battery pack 100 without acting on the securing element 246a, the securing element 246a is actuated during insertion by the previously described engagement means 256b, the securing element 246a comprising an insertion slope 278a for this purpose.

FIG. 16 shows a plan view of a further embodiment of the securing unit 244c. As in the embodiments described immediately hereinabove, the securing unit 244c is provided for battery packs 100 that are mounted linearly or purely axially.

In contrast to the previous securing elements 246c, the securing element 246c of the securing unit 244c is not arranged in the second section 2 of the guide unit 216c, but in the first section 1 of the guide unit 216c. As a result, the securing unit 244c is at a distance 280c from the locking unit 212c that is less than 50% of the length of the battery pack 100.

The securing element 246c is designed as a spring element, e.g. as a wire spring. The securing element 246c is designed such that the frictional force between the guide unit 216c and the battery pack 100 is increased when the securing element 246c is acted upon by the battery pack 100. The securing element 246c and the battery pack 100 are designed such that the frictional force in the connection direction 270c is greater than in the opposite removal direction. By way of example, the securing element 246c comprises an insertion slope 278c which has a smaller slope relative to the connecting direction 270c than the stop element 276c, which is also designed as a slope.

The securing element 246c is mounted on the underside of the guide rail 222c and protrudes laterally into one side of the guide groove 223c. When connecting or detaching the battery pack 100, the securing element 246c is pressed into the guide rail 222c by the axial movement of the battery pack 100 and thus moved.

FIG. 17 shows a side view of the battery pack 100 in the unlocked state, but secured by the securing unit 244c. The battery pack 100 is thereby ejected by the locking unit 212c such that the battery pack 100, in particular the connecting means 202 of the battery pack 100, comes to rest against the securing element 246c, in particular the stop element 276c, and is held by the securing element 246c. For this purpose, the connecting means 202 is shaped in particular such that it increases the outer diameter of the battery pack 100 in some areas. To release the securing mechanism, the battery pack 100 is gripped by the user and pulled against the direction of connection 270c.

FIG. 18 shows a further alternative embodiment of the securing unit 244c in a perspective view. The securing unit 244d is also provided for the purely axial/linear connection and is arranged in the first section 1 of the guide unit 216d. The securing unit 244d in this case comprises four securing elements 246d, which are designed as metallic leaf springs. The securing elements 246d are, by way of example, connected to the guide rail 222d and project into the two opposing guide grooves 223d.

In order to enable a modular detaching for different frame geometries and installation types of different electric bikes, the connecting device 200 according to FIG. 6 is designed such that the actuating unit 240 can be mounted in different arrangements relative to the guide unit 216 and/or relative to the locking unit 212. On the one hand, the actuating unit 240 is accommodated in the receptacle housing 238. Alternatively (and not shown), it is also possible to connect the actuating unit 240 rotated by 90° and without the receptacle housing so that the lock 242 is not directed sideways as shown, but upwards. Given that the frames of electric bikes generally require an opening in the frame to operate the lock, the option of adapting the orientation of the operating unit 240 in a modular fashion is very advantageous. For this purpose, a further component can be mounted on the actuating unit, which is pushed onto the existing unlocking interface and enables a transfer to another unlocking interface by means of an incline.

In order to be able to arrange the actuating unit 240 or the lock 242 not only on different sides, but also at different installation depths, the connecting device 200 is designed such that the actuating unit 240 can be fixed at a first position 304 and at a second position 304 within the receptacle housing 238 along the receptacle direction 299, as can be seen in FIG. 19.

For this purpose, the actuating unit 240 comprises a first connecting element 300 which is, by way of example, designed as a circular bore 301. The receptacle housing 238 for the actuating unit 240 comprises two second connecting elements 302, which are, by way of example, designed as circular recesses 303.

The connecting elements 300, 302 are in this case arranged such that, when the actuating unit 240 is pushed into the receptacle housing 238 in a straight line, the front second connecting element 302 first overlaps with the first connecting element 300 in the first position 304 and, when it is pushed in further, the rear second connecting element 302 overlaps with the first connecting element 300 in the second position 306.

In addition, the connecting device 200 comprises a positioning element 308 that is designed to fix the actuating unit 240 in the receptacle housing 238 in the first position 304 and in the second position 306, whereby the actuating unit 240 has a greater installation depth in the second position 306 than in the first position 304.

FIG. 20 shows a cross-section through the connecting device 200 with an actuating unit 240 in the fixed state in the second position 306.

The positioning element 308 comprises a fixing section 310 for fixing the positioning element 308 in the actuating unit 240. By way of example, the fixing section 310 is essentially pin-shaped and comprises a spring arm 312, which is pressed in when connected and thereby forms a fixing biasing force. The preload force creates a frictional connection between the positioning element 308 and the first connecting element 300 and the positioning element 308.

In addition, the positioning element 308 comprises a retaining section 314, which is designed to fastening the positioning element 308 to the receptacle housing 238. The retaining section 314 is, by way of example, designed as a latching hook 316, which is designed for connection to a corresponding latching contour 318 on the outer surface of the receptacle housing 238. The retaining section 314 and the fixing section 310 are connected to each other via a preferably elastic connecting web 320.

To position the actuating unit 240 in the receptacle housing 238, the actuating unit 240 is first pushed linearly into the receptacle housing 238 up to the first position 304 or up to the second position 306. The positioning element 308 is then pushed, with the fixing section 310 in front, through the second connecting element 302 of the receptacle housing 238 into the first connecting element 300 of the actuating unit 240. The insertion movement ends when the retaining section 314 of the positioning element 308 snaps into the corresponding latching contour 318 on the receptacle housing 238. To release the connection, the elastic retaining section 314 can be bent outwards by a user in order to pull out the positioning element 308 after releasing the interlocking connection.

FIG. 21 shows an alternative embodiment of an actuating unit 240e, which can also be fixed in different positions in an alternative receptacle housing 238e (see FIG. 22) for the actuating unit 240e.

In contrast to the two discrete positions in the previous exemplary embodiment, in this embodiment a stepless adjustment of the position of the actuating unit 240e in the receptacle housing 238e is possible. The actuating unit 240e comprises, by way of example, two first connecting elements 300e in the form of slotted holes 322e, whereby a positioning element 308e in the form of a screw 324e is arranged in each of the slotted holes 322e. The positioning elements 308 are initially arranged movably in the slotted hole 322e in the unfastened state.

The receptacle housing 238e comprises, by way of example, two second connecting elements 302e, which are also designed as elongated holes 326e, whereby the elongated holes 326e of the receptacle housing 238e correspond in their positioning and dimension to the elongated holes 322e of the actuating unit 240e. Furthermore, the receptacle housing 238e comprises two fixing elements 328e for clamping the actuating unit 240e to the receptacle housing 238e.

In the connected state, the actuating unit 240e can be displaced linearly relative to the receptacle housing 238e within the limits set by the fixing elements 328e and fixed by the screws 324e.

FIG. 23 and FIG. 24 show a further alternative embodiment of a receptacle housing 238f and an actuating unit 240f, which can be fixed in different positions relative to one another. In contrast to the previous embodiments, the first connecting elements 300f of the actuating unit 240f and the second connecting elements 302f of the receptacle housing 238f can be directly connected to each other and no additional positioning element is required.

The connecting elements 300f, 302f each have a plurality of latching elements 330f, for example ten latching elements 330f. Advantageously, the actuating unit 240f can thus be accommodated in ten different positions in the receptacle housing 238f.

The first connecting elements 300f are, by way of example, arranged on an inner side of a cap 332f, which is firmly connected to the actuating unit 240f. The cap 332f and the actuating unit 240f can be designed integrally. The fixed connection in this embodiment is, e.g., a bonded connection performed by adhesion. Advantageously, the actuating unit 240 according to FIG. 19 can thus be adapted for further configurations by the cap 332f. The second connecting elements 302f are arranged on an outer side of the receptacle housing 238f.

In FIG. 23, the actuating unit 240f is, by way of example, fastened in a middle position and, in FIG. 24, in an end position at the greatest possible installation depth. For better mounting, two spacers 334f are, by way of example, used in this case and are inserted into the receptacle housing 238f before mounting the actuating unit 240f and on which the actuating unit 240f rests. The spacers 334f can, by way of example, be elastically made of a soft plastic, or also of a hard plastic. In the end position, preferably no use of spacers 334f is necessary.

FIG. 25 shows a cross-section of the housing 102 of the battery pack 100. A cell holder 122 for holding the battery cells 124 is arranged in the receptacle 102. For example, five battery cells 124 are arranged next to each other in the housing 102 of the battery pack 100. The cell holder 122 comprises individual cell receptacles for individually receiving the battery cells 124. In addition, a printed circuit board 126 is arranged in the housing 102 of the battery pack 100, which is assigned to a battery management system.

Viewed in cross-section, the contour of the central housing part 105 of the battery pack 100 essentially follows the shape of the cell holder 122 or the battery cells 124.

The housing 102, in particular the central housing part 105, has a ribbed structure 130 on its outer surface 128. The ribbed structure 130 comprises a plurality of ribs 132, between each of which a groove 133 is arranged. The ribs 132 extend parallel to each other and, by way of example, in a straight line along the entire length of the central housing part 105. Advantageously, the ribbed structure 130 increases the surface area of the housing 102, thereby improving the dissipation of heat from the inside of the housing 102 to the outside. By way of example, the ribbed structure occupies over 80% of the outer surface 128 of the housing 102.

The central housing part 105 is, by way of example, made of a plastic, in particular a hard plastic. The ribbed structure 130 is preferably designed integrally with the housing 102, in particular the central housing part 105, of the battery pack 100. The ribbed structure 130 preferably covers the entire outer surface 128 of the center housing part 105. However, the housing 102 can also comprise free surfaces 134 that do not comprise a ribbed structure 130 due to the manufacturing process, or as a placeholder for product information.

The distance between the central housing part 105 and the cell holder 122 is preferably smaller than a thickness D of the housing part 104. A section of the ribbed structure as shown in FIG. 24 is shown in cross-section in FIG. 26.

The ribs 132 are at a height H and a distance L from each other. The distance L in this case is, by way of example, designed to be essentially uniform. By way of example, the ribbed structure 130 is designed such that a ratio between the height H of the ribs 132 and the thickness D of the ribs 132 is approximately 0.4.

In addition, the distance L between the ribs 132 is selected such that it is less than 20% of a diameter of the battery cells 124. This further has a positive effect on the robustness of the battery pack 100, since deformation of the plurality of ribs 132 in the event of a fall effectively absorbs the mechanical energy from the housing 102 of the battery pack 100 by deforming the ribs 132. Advantageously, the ribbed structure 130 is also arranged in the curved areas of the outer surface 128, in which the adjacent ribs extend away from each other and in particular further optimize heat transport.

The ribs 132 and the grooves 133 have an exemplary round edge shape.

FIG. 27 shows an alternative profile of a ribbed structure 130g in a partial cross-section. The ribbed structure 130g comprises angular ribs 132g and angular grooves 133g.

FIG. 28 shows a further alternative profile of a ribbed structure 130h, where the ribs 132h have round edges and the grooves 133h have square edges. It would also be conceivable for the ribs 132h to have square edges and the grooves 133h to have round edges.

In FIG. 29, a further alternative profile of a ribbed structure 130i is shown, in which the ribs 132i have a significantly smaller width than the grooves 133i and thus an essentially convex shape of the ribbed structure 130i is formed for the observer.

In FIG. 30, a housing part 104j of a housing 102j for a battery pack is shown in cross-section, which has a further alternative profile of a ribbed structure 130j. The profile has an essentially convex shape, which is barely visible due to the low height H of the ribs 132j in relation to the thickness D of the housing part 104, but nevertheless has an advantageous effect.

The connecting means 202, 203 of the battery pack 100 each have at least one functional section 400 which, in the state connected to the battery pack 100, projects beyond the housing part 104 of the battery pack 100 connected to the connecting means 202, 203. The connecting means 202, 203 are shown in FIG. 31 and FIG. 32 in a plan view in the state connected to the housing 102 of the battery pack 100. The functional sections 400 are located below a contour line 402 of the battery pack 100, which simulates the contour of the battery pack 100, in particular the central housing part 105 of the battery pack 100.

By connecting the battery pack 100 with the connecting means 202, 203, the outer contour of the battery pack 100 is always enlarged in at least one direction. In the present embodiment and by way of example, an enlargement of the outer contour of the battery pack 100 by the connecting means 202, 203 in the connecting direction 270 is mandatory. In this context, “projecting beyond” is to be understood in particular as an enlargement of the outer contour by the connecting means 202, 203 in at least a second direction, which extends perpendicular to the first direction 270. In this case, the second direction is, e.g., directed downwards.

The front connecting means 202 is screwed to the end plate 106 of the battery pack 100 by means of the fastening element receptacles 206. By way of example, the connecting means 202 comprises a single functional section 400 that projects on a single side. The functional section 400 essentially completely comprises the guide elements 214 of the guide unit 216. In addition, the functional section 400 of the connecting means 202 partially comprises the linear bearing elements 220.

Depending on the configuration of the securing unit 244 of the connecting device 200, the functional section 400 of the connecting means 202 also acts as a stop element 276 for securing the battery pack 100 in the unlocked state (see also FIG. 17).

The rear connecting means 203 in FIG. 32 also comprises a functional section 400. On the side facing away from the battery pack 100, the functional section 400 comprises the partition 118 and the second securing element 114 for the alternative securing unit 244a (see also FIG. 12). In addition, the functional section 400 of an opposite side, in particular on the side facing the battery pack 100), comprises the previously described engagement means 256 and retaining elements 260 for connecting the battery pack 100 to the electric bike 16 (see FIG. 4).

In FIG. 33, an alternative embodiment of a frame 20k is shown in a schematic view, whereby the frame 20k of the electric bike 16k comprises an integrated guide unit 216k. In particular, the frame 20k is shaped such that the battery pack 100 can be guided directly through the frame 20k, in particular a guide element 410k of the frame 20k designed integrally with the frame 20k, by means of the front connecting means 202 and/or the rear connecting means 203 on the battery pack 100.

The guide element 410k of the frame 20k essentially corresponds in its geometry to the guide rail 222 of the connecting device 200 according to FIG. 3 with an exemplary trapezoidal cross-section. The guide elements 214 of the battery pack 100 or the connecting means 202 are in direct contact with the inside of the frame 20k of the electric bike 16k for guidance.

In FIG. 34, a first connecting means 202l and a second connecting means 203l are designed for fastening to a battery pack 100 with an alternative embodiment of the functional section 400. The connecting means 202l can be connected to the housing 102 of the battery pack 100 as shown in FIG. 2 via the respective fastening element receptacles 206l, 258l.

In particular, the connecting means 202l, 203l have a plurality of functional sections 400l which project laterally beyond the battery pack 100. The functional sections 400l are, by way of example, designed as rectangular lugs 412l, which extend in a straight line transversely, in particular perpendicularly, to the longitudinal extension of the battery pack 100. By way of example, the connecting means 202l, 203l each have two functional sections 400l on each side, i.e. a total of eight functional sections 400l. However, it is also conceivable that only one functional section, several functional sections or a different number of functional sections are arranged on each side.

The functional sections 400l arranged on one of the connecting means 202l, 203l have the same length 414l, for example. The length 414l is the length by which the functional section 400l projects beyond the contour of the connected housing part 104 of the battery pack 100.

The functional sections 400l are, by way of example, designed as guide elements 214l, which are provided for guiding the battery pack 100 during the connection process. The length 414l, in particular the length 414l and shape, of the guide elements 214l is adapted to a geometry of the frame 20 of the electric bike. Alternatively or additionally, it is also conceivable that at least one of the functional sections 400l is designed as a securing element.

FIG. 35 shows a schematic view of a further embodiment of a connecting means 202m. The connecting means 202m comprises, by way of example, four fastening element receptacles 206m for fastening the connecting means 202m to the battery pack 100 as shown in FIG. 2. The connecting means 202m is shown in a state connected to a frame 20m of an electric bike 16m, whereby the frame 20m has an essentially oval-shaped cross-section in the receptacle area for the battery pack 100.

By way of example, the connecting means 202m comprises four functional sections 400m, which enlarge the outer contour of the battery pack 100, particularly laterally. In particular, the connecting means 202m comprises three functional sections 400m, which are designed as guide elements 214m, e.g. in the form of sliding surfaces 416m. The frame 20m comprises corresponding guide elements 410m on its inner surface. The guide elements 410m of the frame 20m are, by way of example, designed as damping elements 411m. The damping elements 411m are, by way of example, made of an elastic plastic, in particular of a rubber. Alternatively, it would also be conceivable that the guide elements 410m in the frame 20m are made of a metallic material or designed integrally with the frame 20m.

In addition, the connecting means 202m comprises a functional section 400m comprising an alignment member 418m, whereby the alignment member 418m is provided for aligning and properly connecting the battery pack to the electric bike. In particular, the alignment element 418m can ensure that the battery pack can only be swivelled or pushed into the frame in a single orientation with respect to the frame. The frame 20m comprises a corresponding alignment element 420m, whereby the corresponding alignment element 420m of the frame 20m and the alignment element 418m of the connecting means 202m form an interlocking connection, at least in sections, during the connection process. The alignment element 418m and/or the corresponding alignment element 420m can additionally feature a guiding function. The connecting means 202m can comprise a single alignment element 418m or a plurality of alignment elements. The alignment element 418m is, by way of example, notch-shaped with a particularly V-shaped cross-section.

FIG. 36 shows a schematic view of a further embodiment of a connecting means 202n. The connecting means 202n comprises, by way of example, four fastening element receptacles 206n for fastening the connecting means 202n to the battery pack 100 as shown in FIG. 2. The connecting means 202n is shown in a state connected to a frame 20n of an electric bike 16n, the frame 20n having an essentially oval-shaped cross-section, the frame 20n comprising two chambers 21n. The smaller chamber 21n is intended for guiding cable elements 23n in the frame 20n and the larger chamber 21n forms the receptacle area for the battery pack 100.

By way of example, the connecting means 202n comprises four fastening element receptacles 206n for fastening to the battery pack. The connecting means 202n comprises a functional section 400n which is adapted to the cross-section of the frame 20n, in particular to the cross-section of the receptacle area for the battery pack. As an example, the functional section 400n is circumferential and forms a guide element 214n for guiding the battery pack 100 in the frame 20n. The frame 20n comprises no special guide elements on its inner surface. In order to ensure only a single connection option with the battery pack, the frame 20n is designed such that the cross-section is asymmetrical.

The connecting means 203 also comprises a removal aid 500 (see FIG. 12), which is designed to support the removal of the battery pack 100 from the frame 20 of the electric bike 16. Due to the integration of the battery pack 100 into the frame 20, releasing the connection can be challenging depending on the frame geometry and also depending on the size of a user's hand. By integrating the removal aid 500 into the connecting means 203, the battery pack 100 can be adapted to the existing geometric conditions and optimally designed for the user.

The removal aid 500 is, by way of example, designed as an engagement recess 502. The removal aid 500 is, by way of example, arranged on a side of the connecting means 203 facing away from the battery pack 100. The removal aid 500 is arranged centrally in the connecting means 203, for example, but a non-central arrangement would also be conceivable. The removal aid 500 is, by way of example, designed integrally with the connecting means 203. However, it would also be conceivable that the removal aid 500 is made of a different material and is connected to the connecting means 203 in a force-fit and/or form-fit or material-fit manner.

The battery pack 100, in particular the connecting means 203, comprises a single removal aid 500. However, it would also be conceivable for the connecting means 203 or the battery pack 100 to have several removal aids 500, which are arranged, for example, on both connecting means 202, 203.

The removal aid 500 comprises a partial area with a surface structure 504 to increase the roughness. The surface structure 504 comprises, by way of example, three rib-shaped elevations 506 that run parallel to one another.

In FIG. 37, an alternative embodiment of a connecting means 202o with a removal aid 502o is shown in a front view and in FIG. 38 in a perspective view. The connecting means 202o is intended for a battery pack that can be connected with a swivel-in operation. The connecting means 202o can be provided for the battery pack 100 described above or another battery pack.

The connecting means 202o comprises a guide unit 216o having at least one guide element 214o, which is provided for guiding the battery pack along the swivelling direction 506o during the connection process. The guide element 214o is, by way of example, designed as an essentially rectilinear web. Adjacent to the guide element 214o, the connecting means 202o comprises two receptacle openings 512o on a first side, in particular on an underside, for receiving corresponding connecting elements (not shown) in the electric bike.

Furthermore, the connecting means 202o comprises a locking element 508o, which is provided for locking the battery pack. The locking element 508o is, by way of example, designed as a metallic locking element receptacle 510o, into which a locking element of the electric bike, (not shown) engages in the locked state. The connecting means 202o is, by way of example, made of a plastic, in particular a hard plastic. The locking element 508o is, by way of example, fastened to the connecting means 202o by means of a clip connection.

In addition, the connecting means 202o comprises two securing elements 110o of a securing unit 244o which is, by way of example, hook-shaped and can be actuated via an actuating element 245o. The two securing elements 246o are integrally connected to each other via the actuating element 245o. The actuating element 245o is, by way of example, arranged on a second side, which is arranged opposite the first side. The actuating element 245o is designed such that when the actuating element 245o is subjected to a force in the direction of the battery pack, the securing elements 244o are also pressed in and thus a securing device can be released.

For fastening the connecting means 202o to a battery pack, the connecting means 202o comprises, by way of example, four fastening element receptacles 206o. In the region of the first side, the connecting means 202o comprises two first fastening element receptacles 514o in the region of the first side and two second fastening element receptacles 516o in the region of the opposite second side.

The first fastening element receptacles 514o in the region of the first side are essentially adapted in cross-section to a head region of the screw, so that the fastening element receptacle 514o is bounded by a continuous wall 515o.

In contrast to the first fastening element receptacles 514o in the area of the first side, the second fastening element receptacles 516o in the area of the second side are only partially adapted to the screw or the head area of the screw. A wall 517o radially delimiting the fastening element receptacle 516o is not continuous and is open to the outside.

Through the opening 518o to the outside, the fastening element receptacle 516o is enlarged such that it forms a removal aid 500o for removing the battery pack. In particular, both fastening element receptacles 516o in the region of the second side are designed as removal aids 500o, with the respective opening 518o being arranged on opposite sides for engagement by the user. For example, the user can grip the connecting means 202o laterally with one hand using the thumb and index finger and, for example, pull the battery pack out of a frame using a swivel movement.

To further facilitate removal, the removal aid 500o, in particular the wall 517o delimiting the fastening element receptacle 514o, comprises a surface structure 504o. The surface structure 504o is, by way of example, designed as a serration 520o. The serration 520 in this case comprises a large number of pointed teeth 522o (see enlarged illustration in FIG. 39). Alternatively, alternative forms of the surface structure 504o are also conceivable, for example in the form of a surface structure 504p with a serration 520p with convex curvatures 524p (see removal aid 500p in FIG. 40), a corrugation or a comb-like structure.

In FIG. 41, an alternative embodiment of a removal aid 500q of a connecting means 202q is shown in a perspective view. The removal aid 500q is also designed integrally with the fastening element receptacle 206q, whereby, in contrast to the embodiment according to FIG. 37, the user does not engage from the side, but essentially from the front. The fastening element receptacle 206q has an essentially spherical shape, whereby a diameter 523q of the fastening element receptacle 206q is more than 50% larger than a diameter of the screw to be received.

In FIG. 42, a further alternative embodiment of a connecting means 202r is shown in a perspective view, whereby the connecting means 202r differs in particular in the design of the removal aid 500r from the connecting means 202o according to FIG. 37.

The removal aid 500r in this case comprises a connecting element 530r for connecting the connecting means 202r to a loop (not shown). As an alternative to the loop, a differently designed means can also be provided, by means of which the removal can be made possible or simplified. The connecting element 530r is, by way of example, designed in the form of a web 532r adjacent to a lateral opening 534r, in particular in the area of the fastening element receptacle 206r of the connecting means 202r. Alternatively, an arrangement of the side opening 534r would also be conceivable. The lateral opening 534r is bounded on the outside by the web 532r. In the state connected to the loop, the battery pack can be easily removed by pulling the loop. As an example, the lateral opening 534r is essentially quadrangular in shape, although other shapes of openings are also conceivable.

FIG. 43 shows a further alternative embodiment of a removal aid 500s, exemplary for the connecting means 202r according to FIG. 42. The removal aid 500s is designed as an optional removal element 535s. The removal element 535s is partially accommodated via the lateral opening 534r in the area of the fastening element receptacle 506r and can be connected to the connecting means 202r, for example via the screw connection or a clip mechanism. In addition, the removal element 535s comprises a connecting element 530s in the form of a tab 536s, which projects laterally in the state connected to the connecting means 202r. The tab 536s can be used to connect the removal element 535s, in particular the connecting means 202r, to a loop.

The tab 536s thus forms a functional section 400s. The connecting means 202r therefore comprises a receptacle for the releasable and, in particular, optional connection of a functional section 400s.

What is claimed is:

1. A connecting device for connecting a battery pack to an electric bike, comprising:
a guide unit configured to guide the battery pack in a linear manner during a connection process;
a locking unit configured to lock the battery pack to the electric bike, wherein the locking unit is arranged on a first section of the guide unit; and
a securing unit configured to secure the battery pack in the unlocked state,
wherein the securing unit comprises a movable securing element, and
wherein the connecting device is designed such that the battery pack is configured to be connected to the electric bike exclusively by way of a linear movement.

2. The connecting device according to claim 1, wherein the securing unit is arranged on the first section or on a second section of the guide unit.

3. The connecting device according to claim 1, wherein the securing element is designed to be directly actuated.

4. The connecting device according to claim 1, wherein the locking unit is designed to be actuated such that the battery pack is partially ejected during unlocking.

5. The connecting device according to claim 1, wherein:
the locking unit comprises at least one movable locking element, and
the locking element is designed to be pretensioned in the locked state.

6. The connecting device according to claim 1, wherein the locking unit is coupled to an actuating unit, via which the locking unit is designed to be manually actuated.

7. The connecting device according to claim 6, wherein the actuating unit is designed as a lock.

8. The connecting device according to claim 1, wherein the locking unit comprises at least one linear bearing element for bearing the battery pack in the locked state.

9. The connecting device according to claim 1, wherein the securing element is designed as a resilient stop against which the battery pack rests in the unlocked state.

10. The connecting device according to claim 1, wherein the securing element is connected to the guide unit.

11. The connecting device according to claim 1, wherein the securing element is designed to be indirectly manually actuated via the battery pack.

12. An electric bike comprising a connecting device according to claim 1.

13. The battery pack for an electric bike according to claim 12.
